(19) United States
(12) Patent Application Publication
(10) Pub. No.: US 2014/0006092 A1
(43) Pub. Date: Jan. 2, 2014

(54) MANAGEMENT APPARATUS AND MANAGEMENT METHOD

(71) Applicant: FUJITSU LIMITED, Kawasaki-shi (JP)

(72) Inventors: Hideo KAMADA, Yokohama (JP); Kazuyuki ISHIBASHI, Chiba (JP); Ryuichi SATO, Yokohama (JP); Mitsunobu IZUMI, Yokohama (JP); Tuan Anh LE, Yokohama (JP); Kohei HARIKAE, Kawasaki (JP)

(73) Assignee: FUJITSU LIMITED, Kawasaki-shi (JP)

(21) Appl. No.: 13/872,423

(22) Filed: Apr. 29, 2013

(30) Foreign Application Priority Data
Jun. 29, 2012 (JP) 2012-147180

(51) Int. Cl. G06Q 10/06

(52) U.S. Cl. CPC G06Q 10/06316
USPC 705/7.26

(57) ABSTRACT

A management apparatus includes a storing unit configured to store business process association information and task association information; and a control unit configured to generate correlation information in which the business process association information and the task association information are correlated, and configured to store the correlation information in the storing unit, wherein, the control unit, in response to a transfer instruction that transfers the task to be a target of transfer in a first business process to a second business process, generates the correlation information in which the business process association information on the second business process and the task association information on the task to be a target of transfer are correlated, and based on the correlation information, obtains the task association information on the task in the first business process and the task association information on the task in the second business process.

### CROSS-REFERENCE TO RELATED APPLICATION

This application is based upon and claims the benefit of priority of the prior Japanese Patent Application No. 2012-147180, filed on Jun. 29, 2012, the entire contents of which are incorporated herein by reference.

### FIELD

The embodiments discussed herein are related to a management apparatus, a computer-readable medium storing a program, and a management method.

### BACKGROUND

With respect to business management in which computers are used, the flow of a task carried out by a person is represented as a business process. There have been proposed management apparatuses to systematize the business process and carry out management and monitoring for operations. The task, for example, means the content of the operation carried out by the person.

The administrator of the business process sets the flow of the task in the management apparatus as the business process. The executor of the task, for example, inputs the content of the task, the start of execution of the task, the completion of the execution of the task, the temporary stop of the execution of the task, and the restart of the execution of the task, in the management apparatus. Further, the executor inputs what the executor has noticed in terms of the content of the operation of the task or know-how in the form of comments in the management apparatus. Incidentally, the executor of the task is a person who actually carries out the content of the operation of the task.

The management apparatus stores the content of the task for each task in accordance with the inputs and manages the progress status of the business process. The management apparatus displays the data and time of execution, the date and time of completion, and comments with regards to each task. As a result, the administrator and the executor can grasp the progress status of the business process and the content of the task executed by another person. It has been known that the order of the task is transferable in one business process.

### RELATED ART

Japanese Patent Application Laid-Open No. 2003-6399
Japanese National Publication of International Patent Application No. 2006-529042
Japanese National Publication of International Patent Application No. 2009-532791

Generally, the task is completed in one business process. In other words, the task is closed in the one business process. Accordingly, it is possible to transfer the order of the task in the one business process. However, when the task is transferred in a plurality of business processes, some measures need to be taken.

### SUMMARY

According to an aspect of the embodiments, a management apparatus configured to manage progress of a plurality of tasks in a business process which is represented a flow of the tasks, the management apparatus includes: a storing unit configured to store business process association information associated with the business process and task association information associated with the task in the business process; and a control unit configured to generate correlation information in which the business process association information and the task association information are correlated, and configured to store the correlation information in the storing unit, wherein, the control unit, in response to a transfer instruction that transfers the task to be a target of transfer in a first business process to a second business process, generates the correlation information in which the business process association information on the second business process and the task association information on the task to be a target of transfer are correlated, and based on the correlation information, obtains the task association information on the task in the first business process and the task association information on the task in the second business process for use of management of the business process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating one example of the hardware of an information processing system according to the embodiment of the present invention;

FIG. 2 is a block diagram illustrating one example of a software module executed by a management apparatus of FIG. 1;

FIG. 3 is a diagram schematically illustrating an unstructured business process;

FIG. 4 is another diagram schematically illustrating the unstructured business process;

FIG. 5 is a diagram illustrating one example of a screen for the business process generation;

FIG. 6 is a diagram illustrating one example of a business process display screen described in FIG. 5;

FIG. 7 is a diagram illustrating one example of the business process display screen indicating a state where the tasks are sequentially generated according to the manipulation of instructions for generation concerning the tasks, described in FIG. 6;

FIG. 8 is a diagram illustrating one example of a business process generation screen;

FIG. 9 is a diagram illustrating one example of the business process display screen, which is the updated screen of the business process display screen in FIG. 7;

FIG. 10 is a diagram illustrating one example of a business process display screen U6 representing a state where the task list of FIG. 9 is updated;

FIG. 11 is a diagram illustrating one example of the business process display screen representing a state where a business process display screen is switched by the select manipulation, and various manipulations are carried out;

FIG. 12 is a diagram illustrating one example of a business process display screen after having been switched;

FIG. 13 is a diagram illustrating one example of a state where a drop-down list is displayed in FIG. 12;

FIG. 14 is a diagram illustrating one example of a business process display screen after having been switched;

FIG. 15 is a diagram illustrating one example of a process information table in FIG. 2;

FIG. 16 is a diagram illustrating one example of a task information table in FIG. 2;

FIG. 17 is a diagram illustrating one example of a correlation information table in FIG. 2;

FIG. 18 is a diagram illustrating one example of a task history information table in FIG. 2;

FIG. 19 is a flowchart illustrating one example of the flow of task transfer processing that the management apparatus executes;

FIG. 20 is a diagram illustrating one example of a state where the task information table in FIG. 16 is updated;

FIG. 21 is a diagram illustrating one example of a state where the correlation information table in FIG. 17 is updated;

FIG. 22 is a diagram illustrating one example of a state where the task history information table in FIG. 18 is updated;

FIG. 23 is a flowchart illustrating one example of the flow of processing of displaying a business process list and a task list;

FIG. 24 is a flowchart illustrating one example of the flow of the processing of task association information change;

FIG. 25 is a diagram illustrating one example of a state where the task history information table in FIG. 22 is updated;

FIG. 26 is a flowchart illustrating one example of the flow of the processing of task history display;

FIG. 27 is a diagram illustrating another example of the task information table in FIG. 16;

FIG. 28 is a diagram illustrating another example of the correlation information table in FIG. 17;

FIG. 29 is a diagram illustrating another example of the task history information table in FIG. 18;

FIG. 30 is a flowchart illustrating another example of the flow of task transfer processing executed by the management apparatus;

FIG. 31 is a diagram illustrating one example of a state where the task information table in FIG. 27 is updated;

FIG. 32 is a diagram illustrating one example of a state where the correlation information table in FIG. 28 is updated;

FIG. 33 is a diagram illustrating one example of a state where the task history information table in FIG. 29 is updated;

FIG. 34 is a flowchart illustrating another example of the flow of the processing of displaying the business process list and the task list;

FIG. 35 is a flowchart illustrating another example of the flow of the processing of the task association information change;

FIG. 36 is a diagram illustrating one example of a state where the task history information table in FIG. 33 is updated;

FIG. 37 is a flowchart illustrating another example of the flow of the processing of the task history display.

### DESCRIPTION OF EMBODIMENTS

### First Embodiment

(System Configuration)

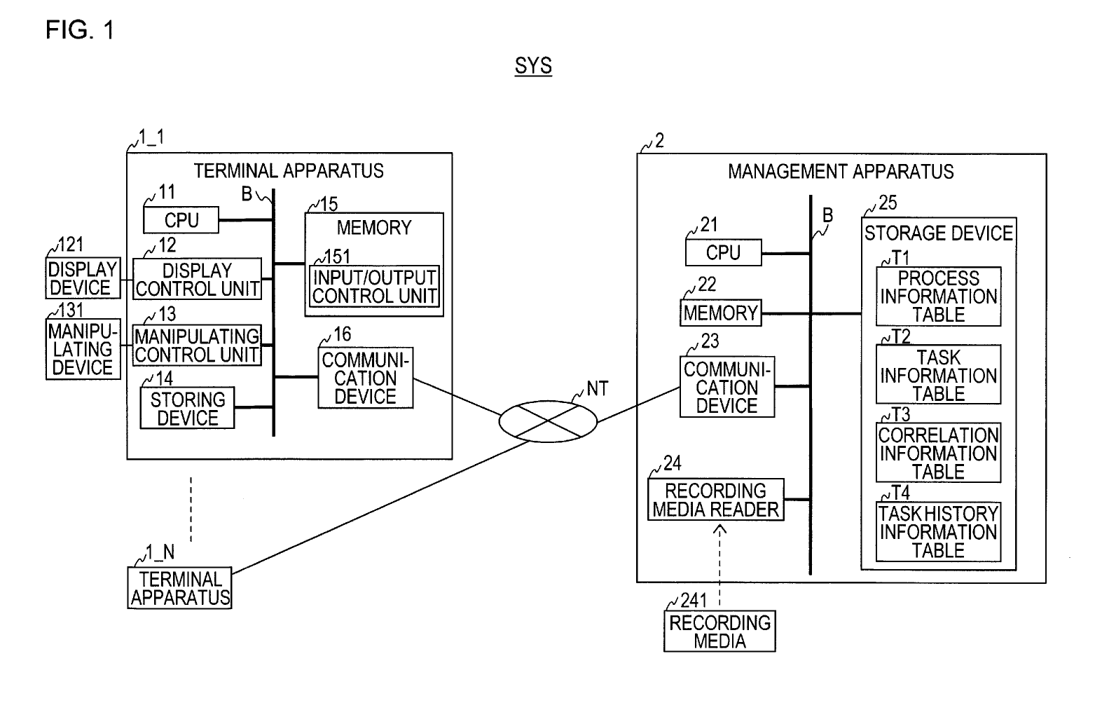

FIG. 1 is a block diagram illustrating one example of the hardware of an information processing system SYS according to the embodiment of the present invention. The information processing system SYS includes N sets of terminal apparatuses (N is an integer of two or more) ranging from a first terminal apparatus 1_1 to an Nth terminal apparatus 1_N and a management apparatus 2. The first terminal apparatus 1_1 to the Nth terminal apparatus 1_N and the management apparatus 2 are mutually coupled via a network NT.

It is noted that the network NT, for example, is exemplified as LAN (Local Area Network).

The first terminal apparatus 1_1 includes a display device 121, such as crystal liquid displays, and a manipulating device 131, such as keyboards and mice, as external devices. The display device 121 and the manipulating device 131 may be included in the first terminal apparatus 1_1 as internal devices. For example, the first terminal apparatus 1_1 includes a CPU (Central Processing Unit) 11, a display control unit 12, a manipulating control unit 13, a storing device 14, a memory 15, and a communication device 16, which are mutually coupled via a bus B.

The CPU 11 is a computer (control unit) to control the entire operation of the first terminal apparatus 1_1. The display control unit 12 executes the processing to display various images on the display device 121. Incidentally, various images are represented as a User Interface screen for the management apparatus 2 described later. Hereinafter, the User Interface screen is appropriately referred to as a UI screen.

In response to the manipulating instructions inputted from the manipulating device 131, the manipulating control unit 13 executes various processing in accordance with the manipulating instructions.

The storing device 14, for example, is exemplified by a magnetic storage device, such as a Hard Disc Drive (HDD), and a non-volatile memory, so as to store various data and programs described later.

The memory 15 temporarily stores various programs and data processed in the course of information processing of all sorts executed by the CPU 11.

An input/output control unit 151 in the memory 15 controls the input processing for various information via the UI screen and the output processing for various information via the UI screen. The input/output control unit 151 is a so-called program, which is stored, for example, in the storing device 14. Upon activation, the CPU 11 reads out the program from the storing device 14 and expands the program in the memory 15, whereby the program functions as a software module. One example of this program includes web browser.

The communication device 16, for example, is exemplified by a Network Interface Card (NIC), coupled to the network NT, and executes the processing of communication with the management apparatus 2.

It is noted that other terminal apparatuses have the same configuration as that of the first terminal apparatus 1_1.

The management apparatus 2 represents the flow of a plurality of tasks as business processes and manages the progress of the tasks in the business processes. For example, the administrator of the business processes manipulates the manipulating device 131 of the first terminal apparatus 1_1 and inputs the names of a task and an executor and the order of processing for the task, which are set (also referred to as “stored”) as the business process by means of the management apparatus 2. The management apparatus 2 manages the business process and the execution state of the task of the business process in response to a task execution starting instruction and a task execution finishing instruction that are inputted by the executor of the task via the manipulating device 131. Further, the management apparatus 2 stores the comments concerning the task, for each task, that are inputted by the executor of the task via the manipulating device 131. The management apparatus 2 stores task history for each task. The task history, for example, includes a start date, a finish date, a temporary stop date, and a restart date. Besides, the task history includes the change that the executor of the task has made, the acceptance of the task execution by the executor of the task, and the declination of the task execution by the executor of the task.

The management apparatus 2, for example, includes a CPU 21, a memory 22, a communication device 23, a recording media reader 24, and a storage device 25, which are mutually coupled via a bus B.

The CPU 21 is a computer (control unit) to control the entire operation of the management apparatus 2. The memory 22 temporarily stores various programs and data processed in the course of information processing of all sorts executed by the CPU 21.

The communication device 23, for example, is exemplified by the Network Interface Card (NIC), coupled to the network NT, and executes the processing of communication with the first terminal apparatus 1_1.

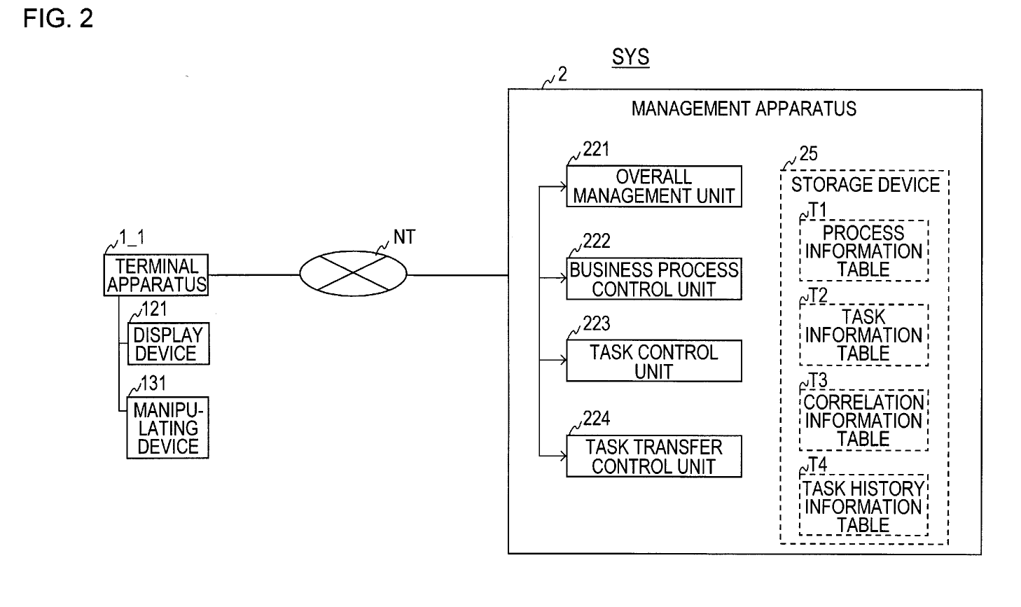

The recording media reader 24 reads data stored in a recording medium 241. The recording medium 241, for example, is portable recording media such as Compact Disc Read Only Memory (CD-ROM) and Digital Versatile Disc (DVD), and Universal Serial BUS (USB). It is noted that programs described in FIG. 2 may be stored in the recording medium 241.

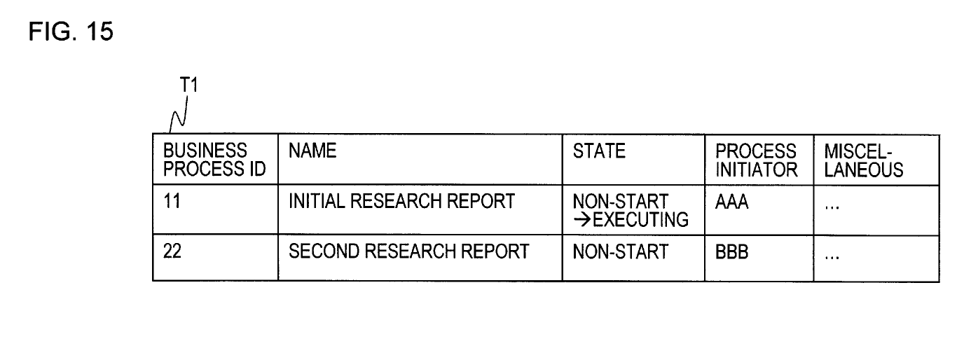

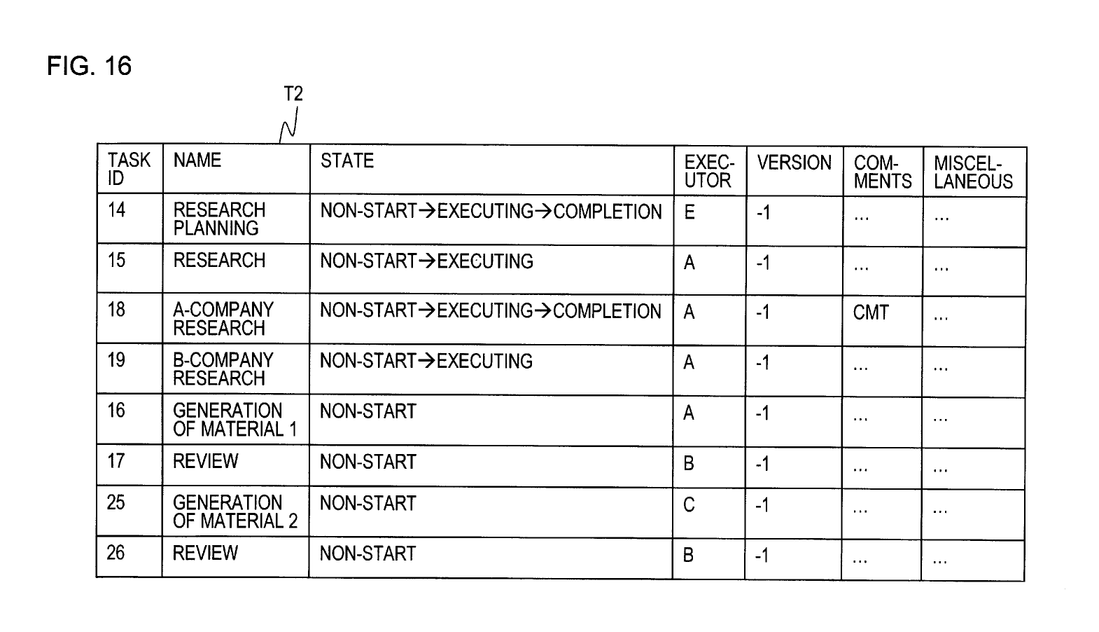

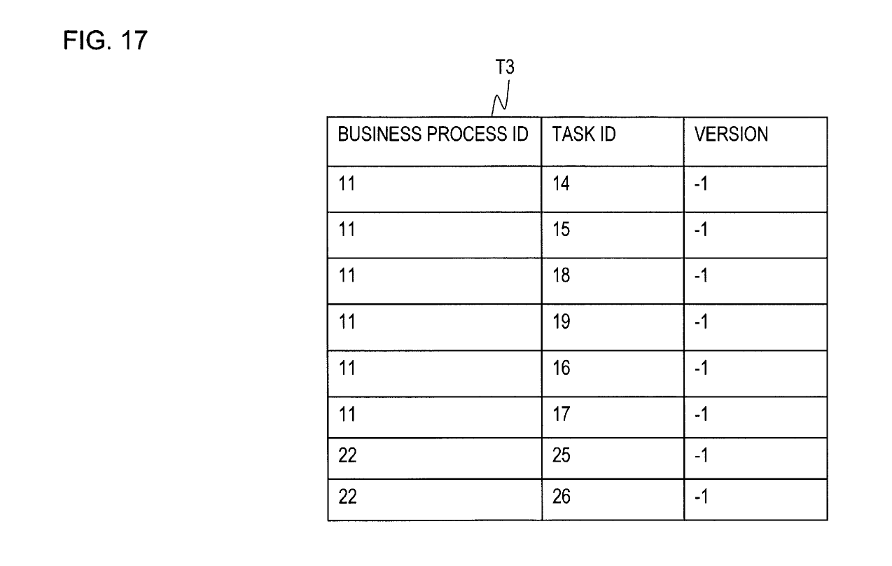

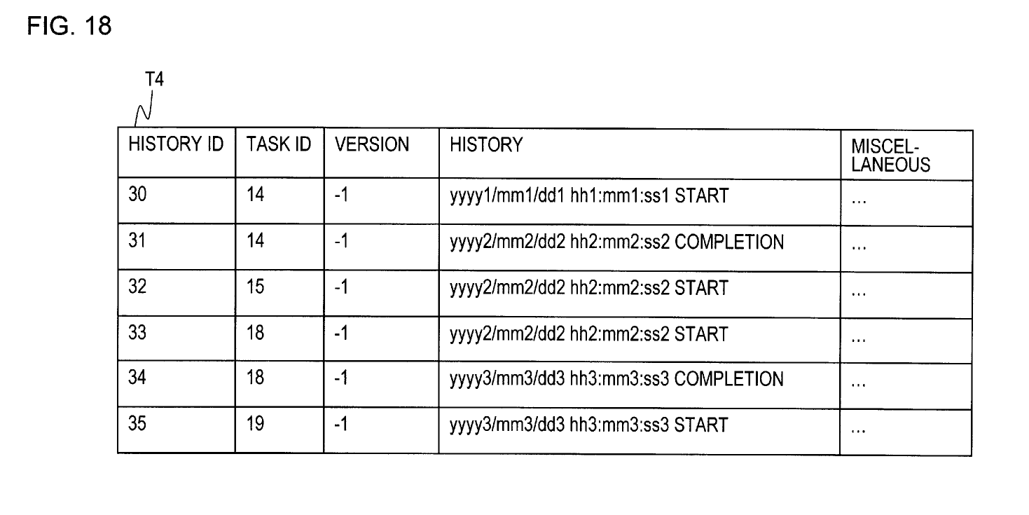

The storage device 25, for example, is exemplified by the magnetic storage device, such as Hard Disc Drive (HDD), or the non-volatile memory. The storage device 25 stores a process information table T1 described in FIG. 15, a task information table T2 described in FIG. 16, a process-task correlation information table T3 described in FIG. 17, and a task history information table T4 described in FIG. 18. Hereinafter, the process-task correlation information table is appropriately referred to as a correlation information table. Further, the storage device 25 stores other programs described later.

(Block Diagram of Software Module of Management Apparatus 2)

FIG. 2 is a block diagram illustrating one example of the software module executed by the management apparatus 2 of FIG. 1. FIG. 2 illustrates the first terminal apparatus 1_1 described in FIG. 1 and the display device 121 and the manipulating device 131 that are coupled to the first terminal apparatus 1_1. Also, the storage device 25, which is a hardware element in the management apparatus 2, the process information table T1, the task information table T2, the correlation information table T3, and the task history information table T4, which are tables, are illustrated in dotted lines in FIG. 2.

An overall management unit 221 manages various processing executed by the management apparatus 2. The overall management unit 221, for example, manages a business process control unit 222, a task control unit 223, and a task transfer control unit 224. Besides, the overall management unit 221 executes the processing of communication with the first terminal apparatus 1_1 and carries out the data generation processing for the UI screen.

The business process control unit 222 carries out various controls regarding the business process including the management of business process information. The business process control unit 222, for example, carries out the processing of storing the name of the business process and the name of a process initiator, which are inputted from the first terminal apparatus 1_1, in the storage device 25 and carries out the access control of the content to be stored.

The business process association information associated with the business process is exemplified by the name of the business process and the name of the process initiator.

The task control unit 223 carries out various controls regarding tasks, which include the management of task information. The task control unit 223, for example, carries out the processing of storing the name of the task, the name of the executor, and comments, which are inputted from the first terminal apparatus 1_1, in the storage device 25 and carries out the access control of the content to be stored. The task association information associated with the task is exemplified by the name of the task, the name of the executor, and the comments.

The task transfer control unit 224 carries out various controls regarding task transfer processing. The task transfer control unit 224, for example, carries out the following processing in response to the transfer instructions for transferring the task to be the target of transfer in a first business process to a second business process subsequent to the first business process. That is, the task transfer control unit 224 generates correlation information that correlates the business process association information of the second business process with the task association information of the task to be the target of transfer, for example, as the process-task correlation information table T3, and stores the correlation information in the storage device 25. The storage device 25 is also referred to as the storing unit. Then, based on the correlation information, the task transfer control unit 224 accesses and obtains the task association information on the task in the first business process and the task association information on the task in the second business process.

The first business process is also called as a business process for a transfer source, and the second business process is also called as a business process for a transfer destination.

The business process control unit 222 generates correlation information including a business process identifier that identifies the business process, as the correlation information described above. The task control unit 223 generates correlation information including a task identifier that identifies the task in the business process and a version numerical value indicating the number of times regarding the transfer of the task. Hereinafter, the business process identifier is appropriately referred to as a business process ID, and the task identifier is referred to as a task ID.

The overall management unit 221, the business process control unit 222, the task control unit 223, and the task transfer control unit 224 are so-called programs. These programs, for example, are stored in the storage device 25 of FIG. 1. Upon activation, the CPU 21 in FIG. 1 reads out these programs from the storage device 25 and expands the programs in the memory 22 of FIG. 1, whereby the programs function as a software module.

It is noted that these programs may be stored in the recording medium 241 to be read by the recording media reader 24 described in FIG. 1. In this case, upon activation, the CPU 21 in FIG. 1 reads out these programs from the recording medium 241 equipped in the recording media reader 24 and expands the programs in the memory 22, whereby the programs function as the software module.

(Outline Description of Business Process)

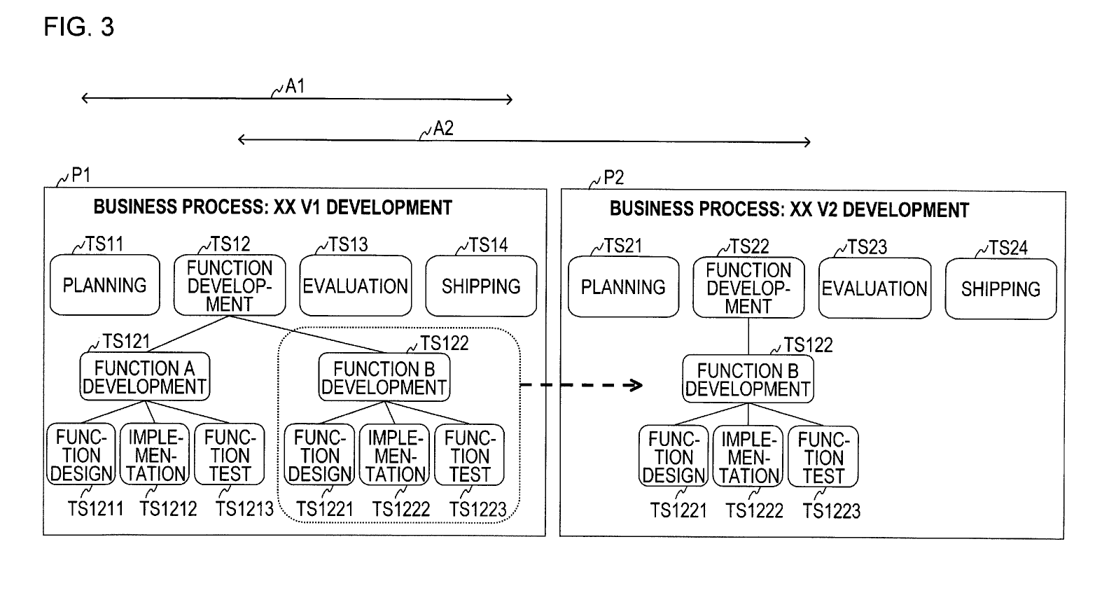

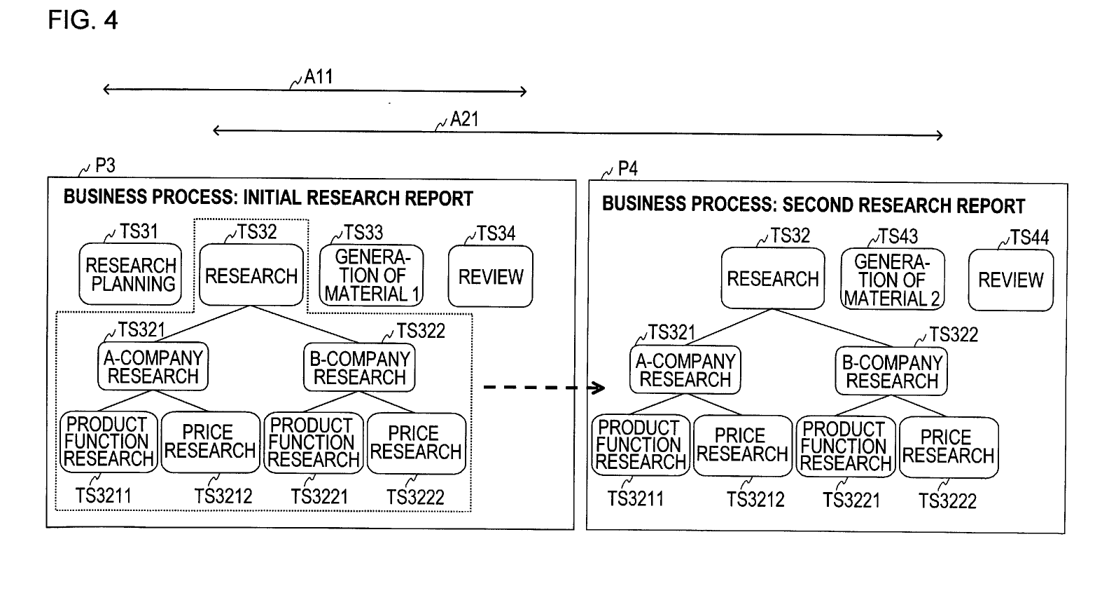

In some case, the management apparatus 2 manages complex business processes such as development business, planning business, and research business, each of which involves a variety of operational content. These complex business processes are also called as an unstructured business process. In these unstructured business processes, there is a case where, based on the judgment of the administrator or executor, the order of tasks having been inputted is dynamically changed, or in the business process, the execution of the tasks having been inputted is temporarily suspended or continued, and taken over to another business process. The outline of the unstructured business process will be described based on FIGS. 3 and 4.

FIG. 3 is a diagram schematically illustrating the unstructured business process. A business process P1 illustrates the business process for developing a product XX of a version V1. In the business process P1, a planning task TS11 of the product XX of the version V1, a function development task TS12 of the product XX, an evaluation task TS13 of the product XX, and a shipping task TS14 of the product XX are represented as the operational content of tasks. These tasks are represented in the flow that the executor of each task sequentially executes the task in time series, from the left to the right of the diagram. The administrator of the business process P1 inputs the planning task TS11, the function development task TS12, the evaluation task TS13, and the shipping task TS14 in the management apparatus 2.

The planning task TS11 indicates the content of planning operation of the product XX, and the function development task TS12 indicates the content of function development operation of the product XX, and the evaluation task TS13 indicates the content of evaluation operation of the product XX, and the shipping task TS14 indicates the content of shipping operation of the product XX.

The executor of a certain task executes his task after the execution of the task in the previous stage is completed. For example, the executor inputs information associated with the task, including comments regarding the operational content, in the management apparatus 2.

The function development task TS12 includes a function A development task TS121 and a function B development task TS122, which are the subtasks of the function development task TS12. A certain task to be subdivided is referred to as the subtask, the certain task is also referred to as a main task. The function A development task TS121 includes a function design task TS1211, an implementation task TS1212, and a function test task TS1213, which are the subtasks of the function A development task TS121. The function B development task TS122 includes a function design task TS1221, an implementation task TS1222, and a function test task TS1223, which are the subtasks of the function B development task TS122. These subtasks are represented in the flow that the executor of each task sequentially executes the task in time series, through the execution of the main task, from the left to the right of the diagram.

Herein, it is assumed that the execution of the planning task TS11 and the function A development task TS121 is completed, and the function B development task TS122 is being executed. The task being executed is in a state where various operations regarding the task are being executed by the executor of the task. In this time, for example, in view of development schedule of the product XX, there is a case where the development of the function B with regards to the product XX of the version V1 is abandoned, and the execution of the next evaluation task TS13 needs to be carried out. In this case, the development of the function B is made when an updated product in terms of the product XX is developed. In other words, the function B development task TS122 is transferred to a development business process P2 for the next version V2. The task to be the target of transfer is also referred to as a task spreading over a plurality of business processes.

The administrator generates the development business process P2 of the product XX of the version V2. In the business process P2, a planning task TS21 of the product XX of the version V2, a function development task TS22 of the product XX, an evaluation task TS23 of the product XX, and a shipping task TS24 of the product XX are represented as the operational content of tasks. The administrator of the business process P2 inputs the planning task TS21, the function development task TS22, the evaluation task TS23, and the shipping task TS24 in the management apparatus 2.

The administrator provides the instruction of transferring the function B development task TS122 in the business process P1 (see a dotted-line enclosure in the diagram) to the business process P2 for the management apparatus 2. Incidentally, an arrow having a reference number A1 schematically indicates a continuation period from the start to the finish of the execution of the business process P1, and an arrow having a reference number A2 schematically indicates a continuation period from the start to the finish of the execution of the function development task to be the target of transfer. Thus, the continuation period of the task to be the target of transfer is longer than a continuation period of one business process.

The management apparatus 2 according to the embodiment of the present invention transfers the function B development task TS122 to the business process P2 in response to the instruction of transferring (see a dotted-line arrow in the diagram). In this case, the management apparatus 2 simultaneously transfers the subtasks. Then, the management apparatus 2 allows the business process P2 for the transfer destination to take over the information on comments associated with the function B development task TS122 to be transferred. Accordingly, there is no need that the administrator newly inputs the information associated with the function B development task TS122 to be transferred. Further, the management apparatus 2 remains the information associated with the function B development task TS122 to be transferred in the business process for the transfer source. Accordingly, in the business process for the transfer source, the management apparatus 2 can access the information associated with the function B development task TS122 to be transferred.

FIG. 4 is another diagram schematically illustrating the unstructured business process. A business process P3 illustrates the business process for examining a certain product. In the business process P3, an research planning task TS31 of the certain product, an research task TS32 of the certain product, a generation task TS33 of an research material 1, and a review task TS34 of the research material 1 are represented as the operational content of tasks. The generation task TS33 of the research material 1 is a task indicating the content of the operation of producing the integrated materials of the research results that the executor of the task has obtained through the execution of the research task TS32. These tasks are sequentially executed in time series from the left to the right of the diagram. The administrator of the business process P3 inputs the research planning task TS31, the research task TS32, the generation task TS33 of the research material 1, and the review task TS34 of the research material 1 in the management apparatus 2.

The executor of a certain task executes his task after the execution of the task in the previous stage is completed. The executor inputs information associated with the task, including comments regarding the operational content, in the management apparatus 2.

The research task TS32 includes an research task of the product of a company A (A-company research task) TS321 and an research task of the product of a company B (B-company research task) TS322, which are the subtasks of the research task TS32. The A-company research task TS321 includes a function research task TS3211 of the product of the company A and a price research task TS3212 of the product of the company A, which are the subtasks of the A-company research task TS321. The B-company research task TS322 includes a function research task TS3221 of the product of the company B and a price research task TS3222 of the product of the company B, which are the subtasks of the B-company research task TS322.

Herein, it is assumed that the execution of the research planning task TS31 and the A-company research task TS321 is completed, and the B-company research task TS322 is being executed. In this time, for example, in view of schedule of the research report of a business process, the research of the product of the company B, which is being executed, is abandoned in an initial research report, and the research of the product of the company B is carried out in the second research report. In other words, the research task TS32 is transferred to a business process P4 for the second research report. In this case, in the business process P3, the execution of the B-company research task TS322 is stopped when being executed, which leads to the execution of the generation task TS33 of the research material 1.

The administrator generates the business process P4 for the second research report. In the business process P4, the research task TS32 of the product to be examined in the business process P3 for the initial research report, a generation task TS43 of an research material 2, and a review task TS44 of the research material 2 are represented as the operational content of tasks. The generation task TS43 of an research material 2 is a task indicating the content of the operation of producing the integrated materials of the research results that the executor of the task has obtained through the execution of the research task TS32. The administrator of the business process P4 inputs the generation task TS43 of an research material 2 and the review task TS44 of the research material 2 in the management apparatus 2.

The administrator provides the instruction of transferring the research task TS32 in the business process P3 (see a dotted-line enclosure in the diagram) to the business process P4 for the management apparatus 2. Incidentally, an arrow having a reference number A11 schematically indicates a continuation period from the start to the finish of the execution of the business process P3, and an arrow having a reference number A21 schematically indicates a continuation period from the start to the finish of the execution of the research task to be the target of transfer. Thus, the continuation period of the task to be the target of transfer is longer than a continuation period of one business process.

The management apparatus 2 according to the embodiment of the present invention transfers the research task TS32 to the business process P4 in response to the transfer instruction (see a dotted-line arrow in the diagram). In this case, the management apparatus 2 transfers the A-company research task TS321 and the B-company research task TS322, which are the subtasks of the research task TS32. Then, the management apparatus 2 allows the business process P4 for the transfer destination to take over the information associated with the research task TS32 to be transferred. Accordingly, there is no need that the administrator newly inputs the information associated with the research task TS32 to be transferred. Further, the management apparatus 2 remains the information associated with the research task TS32 to be transferred in the business process for the transfer source. Accordingly, in the business process for the transfer source, the management apparatus 2 can access the information associated with the research task TS32 to be transferred.

(UI Screen)

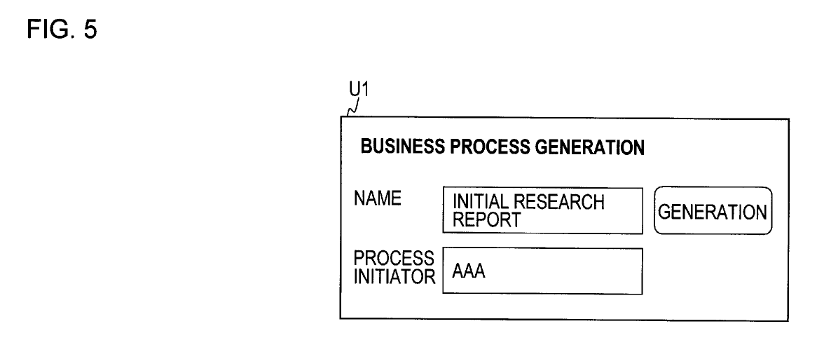

The generations of business processes and tasks according to the administrator will be described referring to FIG. 2, based on FIGS. 5 to 14. In descriptions below, the business process for carrying out the research of the certain product described in FIG. 4 is exemplified. The function research tasks TS3211 and TS3221 and the price research tasks TS3212 and TS3222 described in FIG. 4 are nonessential to describe the function of the management apparatus 2 according to the embodiment of the present invention and omitted in the descriptions below.

The UI screen described in FIGS. 5 to 14 is a screen displayed by the display device 121 of the first terminal apparatus 1_1 in FIG. 2. The input/output control unit 151 displays the UI screen on the display device 121 via the display control unit 12 based on data (hereinafter appropriately referred to as screen data), for example, written by Hypertext Markup Language (HTML) form or Extensible Markup Language (XML) form. The screen data, for example, is generated by the overall management unit 221 of the management apparatus 2 in FIG. 2.

In the descriptions of FIGS. 5 to 14, when the administrator manipulates the manipulating device 131 of the first terminal apparatus 1_1 in FIG. 2, the input/output control unit 151 transmits a control command corresponding to the manipulation to the management apparatus 2 in response to the manipulation. When the overall management unit 221 of the management apparatus 2 receives the control command, the overall management unit 221 executes the processing corresponding to the control command, in response to the control command.

FIG. 5 is a diagram illustrating one example of the screen for the business process generation. The administrator manipulates the manipulating device 131 of the first terminal apparatus 1_1 in FIG. 2 and instructs the overall management unit 221 of the management apparatus 2 to generate a business process. In response to the instruction, the overall management unit 221 generates screen data for the business process generation and transmits the screen data to the first terminal apparatus 1_1. The input/output control unit 151 of the first terminal apparatus 1_1 receives the screen data for the business process generation and displays the data on the display device 121 as business process generation screen U1 in FIG. 5. The business process generation screen U1 includes text boxes corresponding to each column, on the right sides of the name column of the business process and the name of a process initiator, and a generation button.

The administrator manipulates the manipulating device 131 of the first terminal apparatus 1_1 in FIG. 2 and inputs the name of the business process in the text box corresponding to the name column on the business process generation screen U1 and inputs the name of a process initiator in the text box corresponding to the process initiator column. Incidentally, the process initiator, for example, is the administrator of the business process.

In FIG. 5, the administrator manipulates the manipulating device 131, inputs “initial research report”, which is the name of the business process, in the text box corresponding to the name column, and inputs “W”, which is the name of the process initiator, in the text box corresponding to the process initiator column. Then, the administrator manipulates the manipulating device 131 and downwardly pushes the generation button. Incidentally, downwardly pushing, for example, means that an operator manipulates the mouse (not shown) of the manipulating device 131, transfers a mouse pointer (not shown) displayed on the display device 121 onto an element to be pushed, and clicks the left button of the mouse.

The input/output control unit 151 of the first terminal apparatus 1_1 transmits the control commands corresponding to the input manipulation and the downwardly-pushing manipulation to the overall management unit 221 of the management apparatus 2. The overall management unit 221 receives the control commands, generates display screen data for the business process, and transmits the screen data to the first terminal apparatus 1_1. The input/output control unit 151 of the first terminal apparatus 1_1 receives the display screen data for the business process and displays the data on the display device 121 as a business process display screen. When the overall management unit 221 of the management apparatus 2 receives the control commands, the overall management unit 221 instructs the business process control unit 222 to update the process information table T1 corresponding to the input manipulation. In response to the instruction, the business process control unit 222 updates the process information table T1. It is noted that the update is described later.

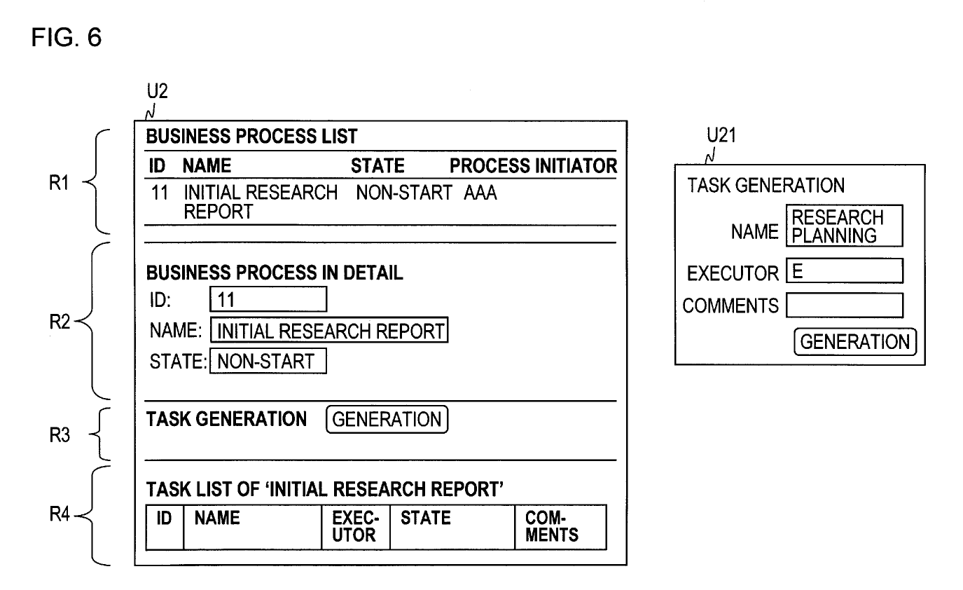

FIG. 6 is a diagram illustrating one example of the business process display screen described in FIG. 5. The business process display screen U2 includes a business process list display column R1, a business process detail display column R2, a task generation display column R3, and a task list display column R4. The business process list display column R1 displays a list of business processes and includes an ID column, a name column, a state column, and a process initiator column.

The ID column displays the identifier of the business process, and the name column displays the name of the business process. The state column displays the states of the business process, such as a non-starting state where the business process has not started yet, an executing state where the business process is being executed, and a completion state where the business process has already completed. The process initiator column displays the process initiator in terms of the business process. Hereinafter, the identifier is appropriately referred to as ID.

The business process detail display column R2 displays the detailed content of the business process that the administrator or executor selects from among the business processes displayed in the list of the business processes. For example, when the administrator selects the business process illustrated as ID11 in the list of the business processes, the input/output control unit 151 of the first terminal apparatus 1_1 displays the detailed content of the selected business process on the business process display screen U2. Incidentally, selecting means that, for example, an operator manipulates the mouse of the manipulating device 131, transfers a mouse pointer displayed on the display device 121 onto an element to be selected, and clicks the left button of the mouse. The business process detail display column R2 displays the ID of the selected business process, the name of the business process, and the state of the business process, in the corresponding text boxes as the detailed content of the business process.

The task generation display column R3 displays the task generation button. The task list display column R4 displays a list of tasks that belong to the business process that the administrator selects from the list of the business processes.

The administrator selects the business process, to which tasks will belong, from the list of the business processes in the business process list display column R1. When the administrator downwardly pushes the task generation button in the task generation display column R3, the input/output control unit 151 of the first terminal apparatus 1_1 displays the task generation screen U21 based on the display screen data for the business process that has been received.

The task generation screen U21 includes a name column, an executor column, a comment column, and a generation button. The task generation screen U21 includes text boxes corresponding to each column on the right side of each column (the name column, the executor column, the comment column).

The administrator manipulates the manipulating device 131, inputs the name of the task to be instructed for generation, in the text box corresponding to the name column, inputs the executor of the task in the text box corresponding to the executor column, and downwardly pushes the generation button. In FIG. 6, “research planning” is inputted as the name of the task, and “E” is inputted as the name of the executor. It is noted that any comments are not inputted in the text box corresponding to the comment column. The input/output control unit 151 of the first terminal apparatus 1_1 transmits the control commands corresponding to the input manipulation and the downwardly-pushing manipulation to the overall management unit 221 of the management apparatus 2.

When the overall management unit 221 receives the control commands, the overall management unit 221 instructs the task control unit 223 to update the task information table T2 and the correlation information table T3 corresponding to the input manipulation. In response to the instruction, the task control unit 223 updates the task information table T2 and the correlation information table T3. It is noted that the update is described later.

The administrator sequentially carries out the manipulation of instructions for generation concerning the tasks with regards to the business process for the initial research report, which is described in FIG. 6.

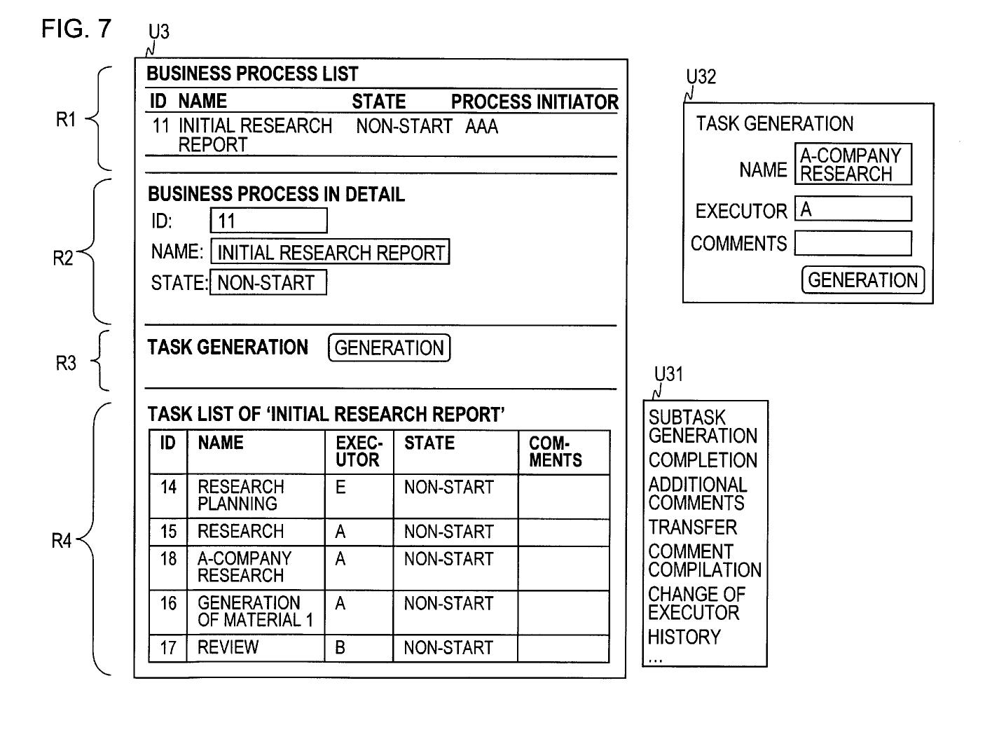

FIG. 7 is a diagram illustrating one example of the business process display screen indicating a state where the tasks are sequentially generated according to the manipulation of instructions for generation concerning the tasks, described in FIG. 6. The task list display column R4 on the business process display screen U3 displays IDs of the tasks having been generated, the names of the tasks, the executors of the tasks, the states of the tasks, and the comments regarding the respective tasks.

As is described in FIG. 6, the administrator instructs the generation of “research planning” task, “research” task, “generation of material 1” task, and “review” task. In this case, the administrator respectively inputs the “E”, “A”, “A”, and “B” as the executors.

The administrator selects “research” task, which is the main task of the subtask which is the “A-company research” task, from the task list, in order to instruct the generation of “A-company research” task, which is the subtask of “research” task. For example, when the mouse of the manipulating device 131 is clicked on the right button thereof, the input/output control unit 151 of the first terminal apparatus 1_1 displays a drop-down list U31 based on the display screen data for the business process that has been received. Hereinafter, the manipulation of clicking the right button of the mouse in a state where a certain task is selected is appropriately referred to as the manipulation of drop-down list display instruction. The drop-down list U31 displays “subtask generation”, “completion”, “additional comments”, “transfer”, “comment compilation”, “change of executor”, “history”, and “ . . . ” as items. The detail of each item is described later.

When the administrator selects “subtask generation” from among the items of the drop-down list U31, the input/output control unit 151 of the first terminal apparatus 1_1 displays task generation screen U32 based on the display screen data for the business process that has been received. The task generation screen U32 includes the same screen configuration as that of the task generation screen U21 in FIG. 6.

The administrator inputs the name of the task to be instructed for generation in the text box corresponding to the name column, inputs the executor of the task in the text box corresponding to the executor column, and downwardly pushes the generation button. In FIG. 7, the administrator inputs “A-company research” as the name of the task and “A” as the name of the executor. The input/output control unit 151 of the first terminal apparatus 1_1 transmits the control commands corresponding to the input manipulation and the downwardly-pushing manipulation to the overall management unit 221 of the management apparatus 2. Further, the administrator inputs “B-company research” as the name of the task and “A” as the name of the executor.

When the overall management unit 221 receives the control commands, the overall management unit 221 instructs the task control unit 223 to update the task information table T2 and the correlation information table T3 corresponding to the input manipulation. In response to the instruction, the task control unit 223 updates the task information table T2 and the correlation information table T3. It is noted that the update is described later.

Further, the overall management unit 221 generates the display screen data for the business process corresponding to the update and transmits the data to the first terminal apparatus 1_1. The input/output control unit 151 of the first terminal apparatus 1_1 receives the display screen data for the business process and displays the data on the display device 121 as the business process display screen.

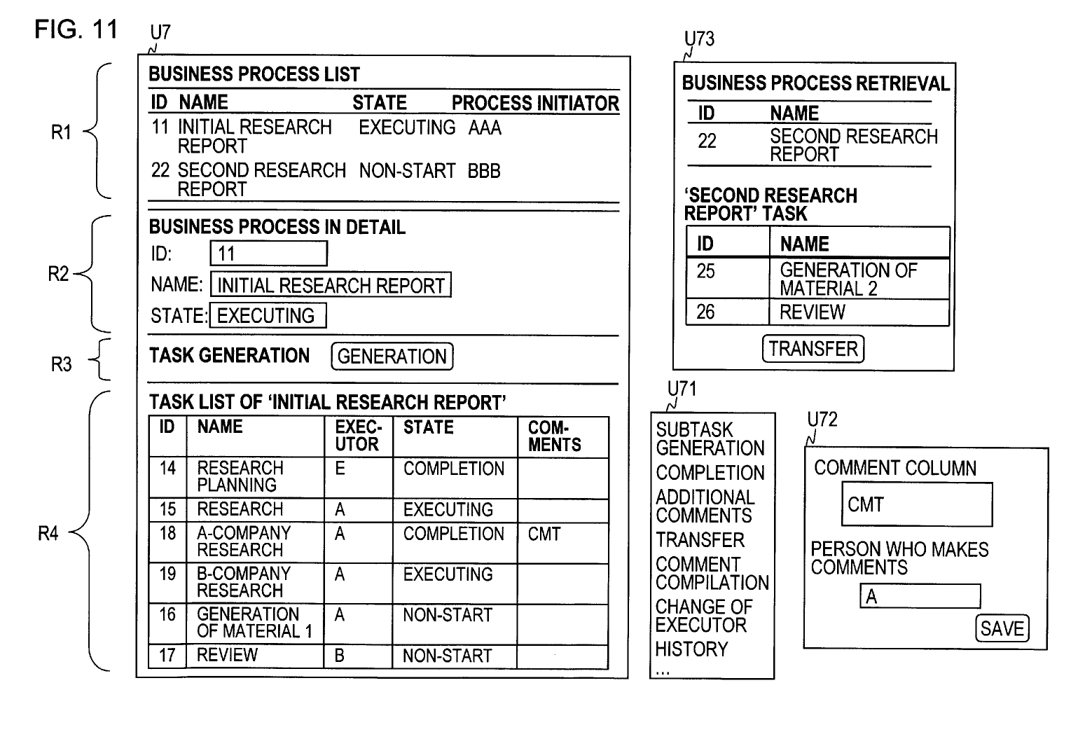

As a result, the input/output control unit 151 of the first terminal apparatus 1_1 displays “A-company research” task, as the subtask of “research” task, in the task list display column R4 on the business process display screen U3. It is noted that the “B-company research” task is represented in FIG. 11.

Then, the process initiator starts “initial research report”, which is the business process. In other words, when the executor starts “research planning”, which is a first task, the manipulation concerning start instructions is carried out in the first terminal apparatus 1_1. The input/output control unit 151 of the first terminal apparatus 1_1 transmits a control command corresponding to the manipulation concerning the start instruction to the overall management unit 221 of the management apparatus 2. In response to the control command, the overall management unit 221 instructs the business process control unit 222 to update the process information table T1, the task information table T2, and the task history information table T4, corresponding to the manipulation concerning the start instructions. In response to the instruction, the business process control unit 222 updates the process information table T1, the task information table T2, and the task history information table T4. It is noted that the update is described later.

Now, the manipulation of instructions for generation concerning the business process for the second research report, which is subsequent to the business process for the initial research report, is carried out. In order to simplify the description of the UI screen, the timing of starting the generation of the business process for the second research report is described earlier, compared with the description in FIG. 4.

As is described in FIG. 5, the administrator manipulates the manipulating device 131 of the first terminal apparatus 1_1 and instructs the overall management unit 221 of the management apparatus 2 to generate the business process. Then, the display device 121 displays the business process generation screen.

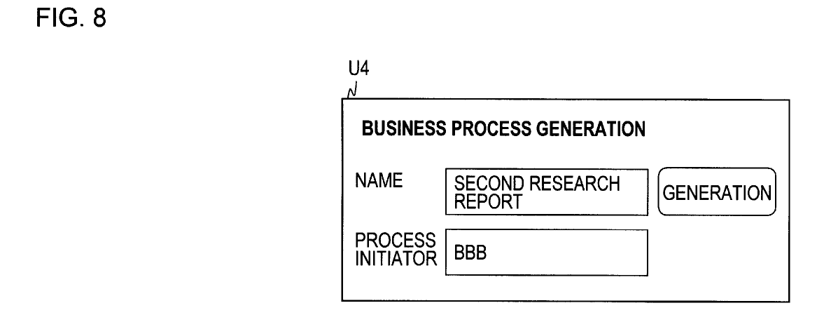

FIG. 8 is a diagram illustrating one example of business process generation screen U4. The administrator manipulates the manipulating device 131, inputs “second research report”, which is the name of the business process, in the text box corresponding to the name column, and inputs “BBB”, which is the name of the process initiator, in the text box corresponding to the process initiator column, on the business process generation screen U4. Then, the administrator manipulates the manipulating device 131 and downwardly pushes the generation button.

As is described in FIG. 6, the display device 121 displays the business process generation screen, which is the update screen of the business process display screen U3 in FIG. 7.

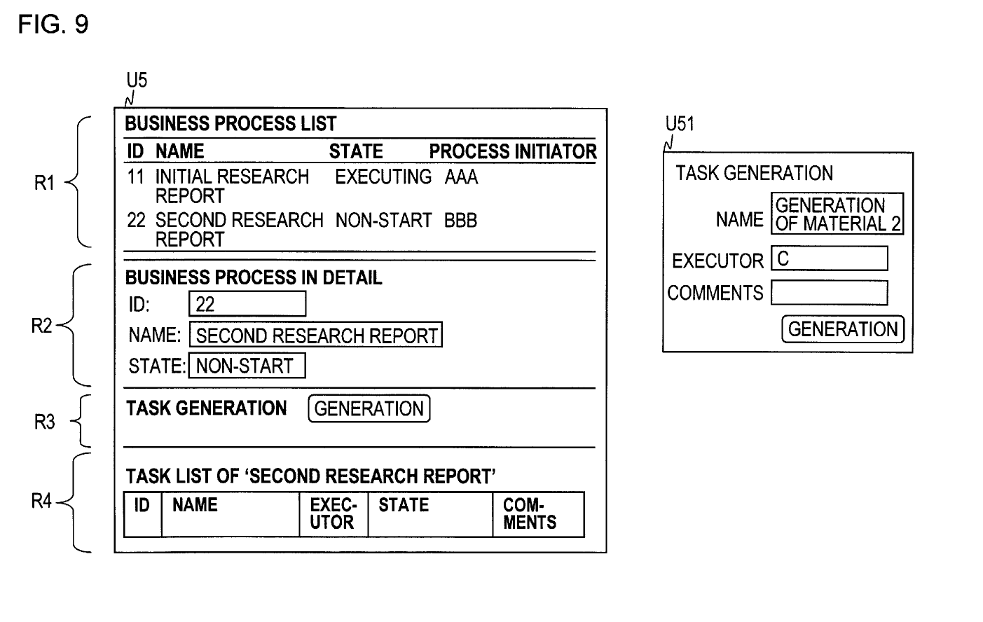

FIG. 9 is a diagram illustrating one example of a business process display screen U5, which is the update screen of the business process display screen U3 in FIG. 7. The input/output control unit 151 of the first terminal apparatus 1_1 additionally displays the business process for the second research report described in FIG. 8 in the business process list display column R1 on the business process display screen U5. Specifically, the input/output control unit 151 of the first terminal apparatus 1_1 displays “22” in the ID column, “second research report” in the name column, “non-start” in the state column, and “BBB” in the process initiator column, in the business process list display column R1. It is noted that the input/output control unit 151 of the first terminal apparatus 1_1 changes “non-start” (see FIG. 7) corresponding to “initial research report” in the state column to “executing” for display, in response to the above-described manipulation of the start instructions according to the process initiator.

As is described in FIG. 6, the administrator selects “second research report”, which is the business process in which the task is generated, from the list of the business processes and downwardly pushes the task generation button. In short, the display device 121 displays a task generation screen U51. The task generation screen U51 has the same screen configuration as that of the task generation screen U21 in FIG. 6.

The administrator inputs the name of the task to be instructed for generation in the text box corresponding to the name column, inputs the executor of the task in the text box corresponding to the executor column, on the task generation screen U51, and downwardly pushes the generation button. On the task generation screen U51 in FIG. 9, the administrator inputs “generation of material 2” as the name of the task and “C” as the name of the executor.

Further, the administrator carries out the manipulation of instructions for generation concerning “review” task. In this case, as is described in FIG. 9, the administrator inputs “review” in the text box corresponding to the name column, inputs “B” as the executor of the task in the text box corresponding to the executor column, on the task generation screen U51, and downwardly pushes the generation button.

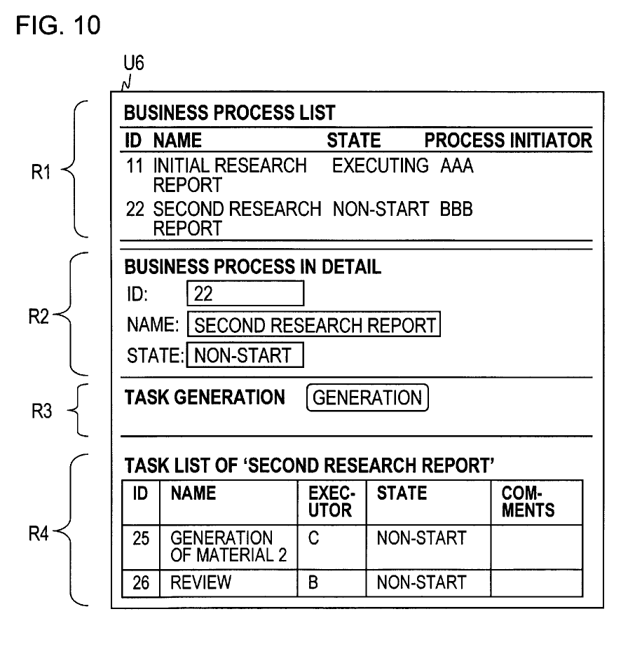

FIG. 10 is a diagram illustrating one example of a business process display screen U6 representing a state where the task list of FIG. 9 is updated.

The task list display column R4 displays “generation of material 2” as the name of the task, “C” as the executor, and “non-start” as the state, according to the ID “25” and further displays “review” as the name of the task, “B” as the executor, and “non-start” as the state, according to the ID “26”.

The administrator carries out the manipulations of selecting the initial research report from the list of the business processes on the business process display screen U6, whereby the business process display screen U6 is switched.

FIG. 11 is a diagram illustrating one example of a business process display screen representing a state where the business process display screen is switched by the select manipulation, and various manipulations are carried out. The business process display screen U7 in FIG. 11 displays the screen in which the content of the business process detail display column R2 and the task list display column R4 is different from that of FIG. 10. In FIG. 11, on the business process display screen U7 immediately after having been switched by the select manipulation, the state of “research planning” task is displayed as “executing”, and the states of “research” task, “A-company research” task, and “B-company research” task are displayed as “non-start”. Further, “CMT” of the comments regarding “A-company research” task is not displayed.

Herein, it is assumed that “E” of the executor of “research planning” task has completed the operational content of the task. In this case, “E” of the executor selects “research planning” task from the task list on the business process display screen U7 in FIG. 11 and instructs the first terminal apparatus 1_1 to carry out the manipulation of a completion setting. The manipulation of the instructions for the completion setting means that an operator selects a task having completed from the task list, and carries out the manipulation of drop-down list display instruction, thereby selecting “completion” item from among the drop-down list to be displayed (see drop-down list U71).

The input/output control unit 151 of the first terminal apparatus 1_1 transmits a control command corresponding to the manipulation of the instructions for the completion setting to the overall management unit 221 of the management apparatus 2. It is noted that the input/output control unit 151 deletes the drop-down list U71.

In response to the control command, the overall management unit 221 instructs the task control unit 223 to update the task information table T2 and the task history information table T4 corresponding to the manipulation of the instructions for the completion setting. In response to the instruction, the task control unit 223 updates the task information table T2 and the task history information table T4. It is noted that the update is described later.

As a result, the input/output control unit 151 of the first terminal apparatus 1_1 replaces “executing” (not shown), as the state of “research planning” task, with “completion” to be displayed in the task list display column R4 on the business process display screen U7 in FIG. 11. Further, the input/output control unit 151 of the first terminal apparatus 1_1 changes the state of “research” task, which is the following task subsequent to “research planning” task, and displays “executing”. Further, the input/output control unit 151 of the first terminal apparatus 1_1 changes the state of “A-company research” task, which is the first subtask of the subtasks of “research” task, and displays “executing” (not shown).

Next, “A” of the executor of “A-company research” task executes the task and inputs comments associated with the operational content of the task. In this case, “A” of the executor selects “A-company research” task from among the task list on the business process display screen U7 in FIG. 11 and carries out the manipulation of drop-down list display instruction.

The input/output control unit 151 of the first terminal apparatus 1_1 displays the drop-down list U71 based on the display screen data for the business process that has been received.

When “A” of the executor selects “additional comments” from among the items in the drop-down list U71, the input/output control unit 151 of the first terminal apparatus 1_1 displays a comment compilation screen U72 based on the display screen data for the business process that has been received. The comment compilation screen U72 includes a text box for inputting comments, a text box for inputting the name of a comment writer, and a save button.

“A” of the executor inputs comments in the text box for inputting comments, inputs “A” as the name of the executor in the text box for inputting the name of the comment writer, and downwardly pushes the save button. For example, “A” of the executor inputs “The reference materials according to the research . . . ” as the comments and inputs “A” as the name of the executor. Hereinafter, the comments are appropriately referred to as character string “CMT”.

The input/output control unit 151 of the first terminal apparatus 1_1 transmits the control commands corresponding to the input manipulation and the downwardly-pushing manipulation to the overall management unit 221 of the management apparatus 2. It is noted that the input/output control unit 151 deletes the drop-down list U71 and the comment compilation screen U72.

When the overall management unit 221 receives the control commands, the overall management unit 221 instructs the task control unit 223 to update the task information table T2 corresponding to the input manipulation, in response to the control command. In response to the instruction, the task control unit 223 updates the task information table T2. It is noted that the update is described later.

As a result, the input/output control unit 151 of the first terminal apparatus 1_1 displays “CMT” in the comment column of “A-company research” task in the task list display column R4 on the business process display screen U7. “CMT” represents “The reference materials according to the research . . . ” character string described above.

Further, it is assumed that “A” of the executor has completed the operational content of “A-company research” task. In this case, “A” of the executor selects “A-company research” task from the task list on the business process display screen U7 in FIG. 11 and instructs the first terminal apparatus 1_1 to carry out the manipulation of the completion setting.

As a result, the input/output control unit 151 of the first terminal apparatus 1_1 changes the state of “A-company research” task, from “executing” to “completion” to be displayed in the task list display column R4 on the business process display screen U7 in FIG. 11. Further, the input/output control unit 151 of the first terminal apparatus 1_1 changes the state of “B-company research” task, which is the following task subsequent to “A-company research” task, and displays “executing” on the business process display screen U7.

As is described in FIG. 4, the administrator transfers “research” task, which is the task with regards to the business process for the initial research report, to the business process for the second research report. In this case, the administrator selects “research” task, which is the task to be the target of transfer, from among the items on the business process display screen U7, and carries out the manipulation of drop-down list display instruction.

The input/output control unit 151 of the first terminal apparatus 1_1 displays the drop-down list U71 based on the display screen data for the business process that has been received.

When the administrator selects “transfer” from among the items of the drop-down list U71, the input/output control unit 151 of the first terminal apparatus 1_1 transmits a control command indicating that the manipulation of transfer instructions for “research” task, which is the task with regards to the business process for the initial research report, has been carried out, to the overall management unit 221 of the management apparatus 2. In response to the control command, the overall management unit 221 retrieves the ID and name of the business process for the transfer destination, except the business process to which the task to be the target of transfer belongs, from the process information table T1. Further, the overall management unit 221 retrieves the ID and name of the task of the business process for the transfer destination, generates screen data for displaying retrieval results, and transmits the screen data to the first terminal apparatus 1_1. When the input/output control unit 151 of the first terminal apparatus 1_1 receives the screen data, the input/output control unit 151 allows the display device 121 to display the screen data.

For example, the input/output control unit 151 of the first terminal apparatus 1_1 displays the screen data as a retrieval result screen U73 in FIG. 11. The retrieval result screen U73 includes a business process retrieval column, a task column, and a transfer button.

The business process retrieval column displays the ID and name of the business process for the transfer destination, which is transmitted from the overall management unit 221. The task column displays the ID and name of the task of the business process for the transfer destination. The retrieval result screen U73 displays “22” as the business process ID and “second research report” as the name of the business process for the transfer destination, and the task column displays “25” and “26” as the task IDs and “generation of material 2” and “review” as the names of the tasks in the business process for the transfer destination.

The administrator selects the process or the task in the process as the transfer destination. In this case, the administrator selects the process with ID “22”. Then, the administrator downwardly pushes the “transfer” button on the retrieval result screen U73. The input/output control unit 151 of the first terminal apparatus 1_1 transmits the control command corresponding to the downwardly-pushing manipulation to the overall management unit 221 of the management apparatus 2. It is noted that the input/output control unit 151 deletes the drop-down list U71 and the retrieval result screen U73.

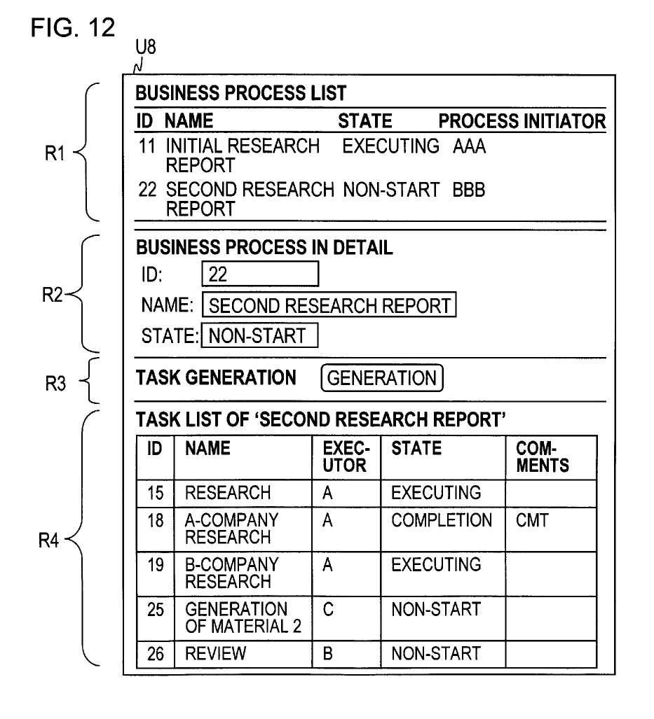

When the overall management unit 221 receives the control command, the overall management unit 221 instructs the task transfer control unit 224 to update the task information table T2, the correlation information table T3, and the task history information table T4, corresponding to the control command. In response to the instruction, the task transfer control unit 224 updates the task information table T2, the correlation information table T3, and the task history information table T4. It is noted that the update is described later. Subsequently, the administrator selects “second research report”, which is the business process for the transfer destination, from the list of business processes on the business process display screen U7. Then, the screen is switched from the business process display screen U7 to the business process display screen in FIG. 12.

FIG. 12 is a diagram illustrating one example of a business process display screen U8 after having been switched. The business process display screen U8 in FIG. 12 corresponds to the business process display screen U6 in FIG. 10, and the content of the task list display column R4 is different from that of U6.

In the task list display column R4 of the business process display screen U8 in FIG. 12, the ID, name, executor, and state of the task to be the target of transfer have been taken over from the business process display screen U7 in FIG. 11. Specifically, the task IDs “15” “18”, and “19” are displayed in the ID column, and “A” of the executor corresponding to each task ID is displayed in the executor column, and the states “executing”, “completion”, and “executing” corresponding to each task ID are displayed in the state column, and the comment “CMT” corresponding to the task ID “18” is displayed in the comment column.

As is described in FIG. 12, the administrator selects the task to be the target of transfer and carries out the manipulation of transfer instruction, whereby the information including comments associated with the task to be the target of transfer is taken over to the business process for the transfer destination and displayed. As a result, there is no need that the administrator newly inputs the information associated with the task in the management apparatus 2, which alleviates work load.

The executor selects a task to be compiled as for comments, from the task list on the business process display screen U8 in FIG. 12, and carries out the manipulation of drop-down list display instruction. Then, the input/output control unit 151 of the first terminal apparatus 1_1 displays the drop-down list based on the display screen data for the business process that has been received.

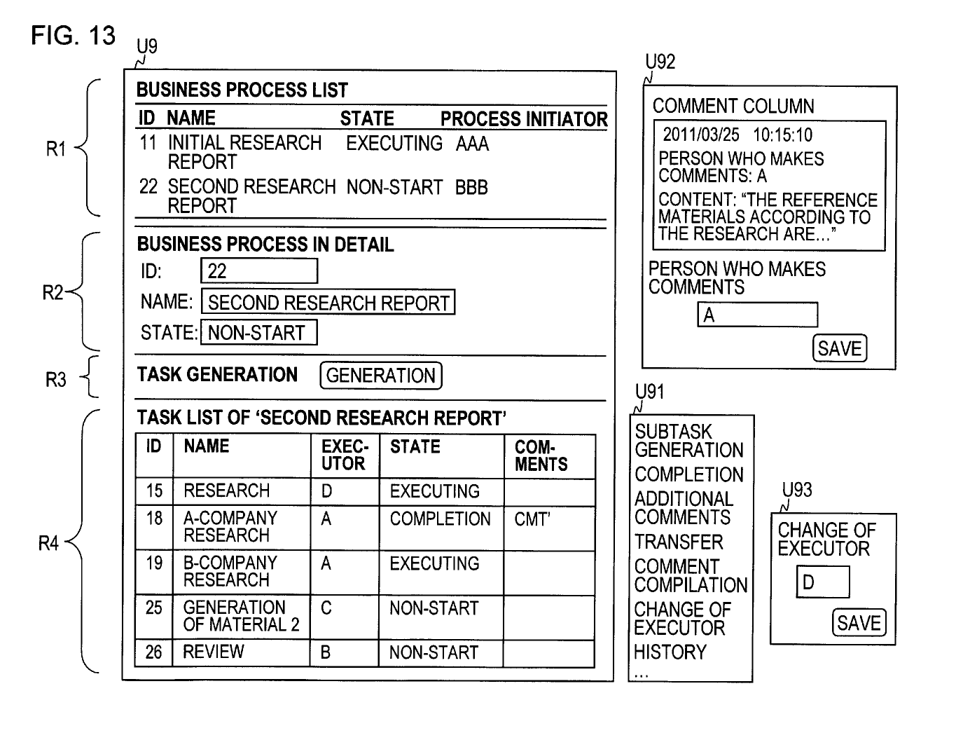

FIG. 13 is a diagram illustrating one example of a state where a drop-down list U91 is displayed in FIG. 12.

The executor selects the “comment compilation” from the drop-down list U91. Then, the input/output control unit 151 of the first terminal apparatus 1_1 displays a comment compilation screen U92 based on the display screen data for the business process that has been received. The comment compilation screen U92 includes the same screen configuration as that of the comment compilation screen U72 in FIG. 11. As is described in FIG. 11, the input/output control unit 151 of the first terminal apparatus 1_1 displays comments, in the text box of the comment column, that are inputted via the comment compilation screen U72, and further displays the comment writer in the text box of the comment writer column. When the executor compiles the text data displayed on the text box of the comment column and downwardly pushes the save button, the input/output control unit 151 of the first terminal apparatus 1_1 transmits the control commands corresponding to the input manipulation and the downwardly-pushing manipulation to the overall management unit 221 of the management apparatus 2. It is noted that the input/output control unit 151 deletes the drop-down list U91 and the comment compilation screen U92.

When the overall management unit 221 receives the control commands, the overall management unit 221 instructs the task control unit 223 to update the task information table T2 corresponding to the input manipulation. In response to the instruction, the task control unit 223 updates the task information table T2. It is noted that the update is described later.

As a result, a business process display screen U9 displays “CMT” in the comment column of the “A-company research” task. “CMT” represents above-mentioned comments after having been compiled.

The administrator selects a task for which executors are changed, from the task list on the business process display screen U9 in FIG. 13 and carries out the manipulation of drop-down list display instruction. Then, the input/output control unit 151 of the first terminal apparatus 1_1 displays the drop-down list based on the display screen data for the business process that has been received. The administrator selects “change of executor” from the drop-down list U91. Then, the input/output control unit 151 of the first terminal apparatus 1_1 displays an executor change screen U93 based on the display screen data for the business process that has been received. The executor change screen U93 includes an executor change column and a save button. The executor change column includes a text box for inputting the name of an executor after having been changed. When the administrator inputs “D” as the name of the executor after the change in the text box of the executor change column and downwardly pushes the save button, the input/output control unit 151 of the first terminal apparatus 1_1 transmits the control commands corresponding to the input manipulation and the downwardly-pushing manipulation to the overall management unit 221 of the management apparatus 2. Also, the input/output control unit 151 of the first terminal apparatus 1_1 displays the name of the executor corresponding to “research” task in the task list display column R4 on the business process display screen U9 as “D”, which is the name of the executor after the change. It is noted that the input/output control unit 151 deletes the drop-down list U91 and the executor change screen U93.

When the overall management unit 221 receives the control command, the overall management unit 221 instructs the task control unit 223 to update the task information table T2 and the task history information table T4, corresponding to the input manipulation. In response to the instructions, the task control unit 223 updates the task information table T2, the correlation information table T3, and the task history information table T4. It is noted that the update is described later.

As is described in FIG. 13, even when the task is transferred to another business process, the administrator can change the name of the executor of the task after the task has been transferred, as needed. As a result, even when the executor of the task is changed in the business process for the transfer destination, the content of the change can be reflected in the management apparatus 2.

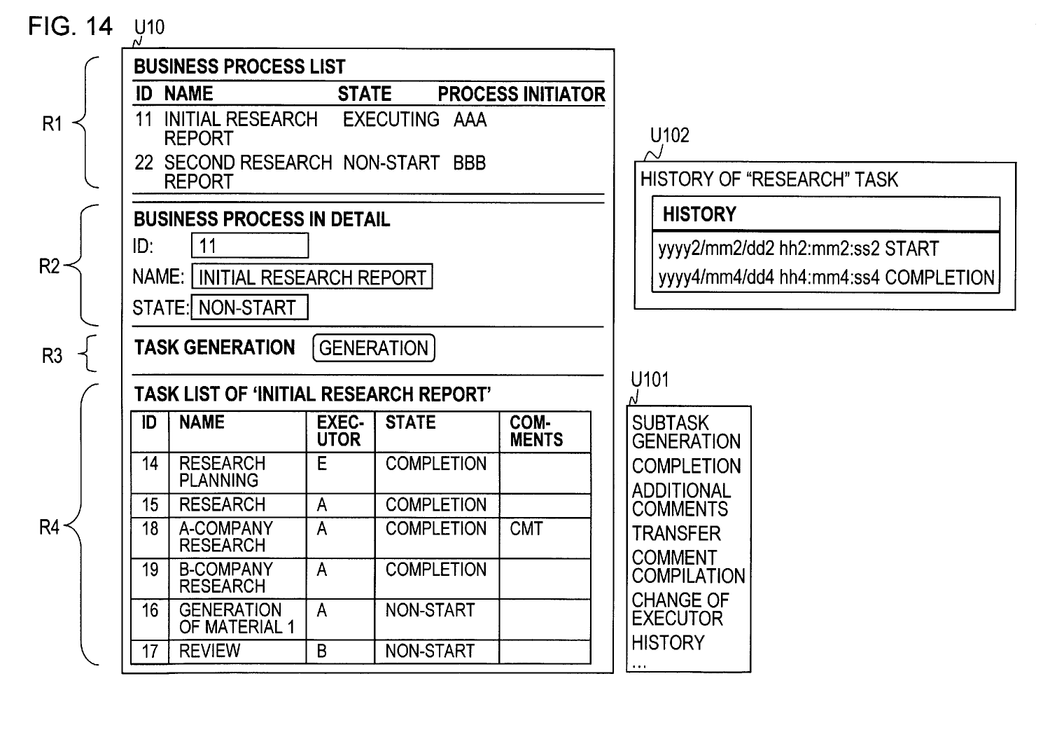

The executor selects “initial research report” process from the list of the business processes on the business process display screen U9. Then, the display screen of the display device 121 is switched from the business process display screen U9 to the business process display screen in FIG. 14.

FIG. 14 is a diagram illustrating one example of a business process display screen U10 after having been switched. The business process display screen U10 in FIG. 14 corresponds to the business process display screen U7 in FIG. 11, and the content of the task list display column R4 is different from that of FIG. 11.

In the task list display column R4 of the business process display screen U10 in FIG. 14, the states corresponding to the task IDs “15” “18”, and “19” are displayed as “completion” in the state column.

The administrator selects a task whose history needs to be displayed, from the task list on the business process display screen U10 in FIG. 14 and carries out the manipulation of drop-down list display instruction. Then, the input/output control unit 151 of the first terminal apparatus 1_1 displays a drop-down list U101 based on the display screen data for the business process that has been received.

The executor selects “history” from the drop-down list U101. The input/output control unit 151 of the first terminal apparatus 1_1 transmits the control command corresponding to the select manipulation to the overall management unit 221 of the management apparatus 2.

When the overall management unit 221 receives the control command, the overall management unit 221 accesses the history information of the selected task in the task history information table T4 of FIG. 2 and transmits the history information to the input/output control unit 151 of the first terminal apparatus 1_1. The input/output control unit 151 of the first terminal apparatus 1_1 displays the history information on the display device 121. A history display screen U102 in FIG. 14 is a screen to display the history information of the task. The history display screen U102 displays the history information of “research” task that is selected by the administrator.

As is described in FIG. 14, even when the task is transferred to another business process, the administrator or the executor can recognize the history of the task in the business process for the transfer source. As a result, the administrator or the executor can recognize the progress status of the business process for the transfer source.

(Table)

Hereinafter, there will be described the processing that the management apparatus 2 executes in response to various manipulations carried out via the UI screens described in FIGS. 5 to 14. First, the process information table T1, the task information table T2, the correlation information table T3, and the task history information table T4 in FIG. 2 will be described.

FIG. 15 is a diagram illustrating one example of the process information table T1 in FIG. 2. The process information table T1 is one example of a third table to store and correlate the business process association information associated with the business process and business process ID that identifies the business process. The process information table T1 includes the business process ID column, the name column, the state column, the process initiator column, and a miscellaneous column.

The business process ID column stores the IDs of the business processes, and the name column stores the corresponding names of the business processes. The state column stores the corresponding states of the business processes, and the process initiator column stores the corresponding process initiators of the business processes. In the state column, “non-start executing” schematically represents that the state is changed from “non-start” to “executing”. Actually, any one of “non-start” or “executing” is stored.

The content of each column corresponds to the list of business processes on the business process display screen described in FIGS. 6 and 9. The miscellaneous column stores various information associated with the business process. It is noted that the content of each column is described later. Hereinafter, “ . . . ” in the tables represents blank.

FIG. 16 is a diagram illustrating one example of the task information table T2 in FIG. 2. In the first embodiment of the present invention, the task information table T2 is one example of a first table to store and correlate the task association information associated with the task and the task ID that identifies the task, and a version value. The task information table T2 includes the task ID column, the name column, the state column, the executor column, a version value column, the comment column, and a miscellaneous column. The task ID column stores the corresponding IDs of the tasks, and the name column stores the corresponding names of the tasks, and the state column stores the corresponding states of the tasks. In the state column, “non-start executing completion” schematically represents that the state is changed from “non-start” to “executing” and further changed from “executing” to “completion”. Actually, any one of “non-start”, “executing”, or “completion” is stored.

The version value column stores the corresponding version value of the task (also referred to as a version numerical value), and the comment column stores the corresponding comments inputted in accordance with the task, and the miscellaneous column stores various information associated with the task.

The content of each column corresponds to the task list on the business process display screen described in FIGS. 6 and 9. It is noted that the content of each column is described later.

FIG. 17 is a diagram illustrating one example of the correlation information table T3 in FIG. 2. In the first embodiment of the present invention, the correlation information table T3 is one example of a second table to store and correlate the business process ID and the task ID, and the version value. The correlation information table T3 includes the business process ID column, the task ID column, and the version value column. The business process ID column stores the business process ID in FIG. 15, and the task ID column stores the ID of the task of the business process that is identified by the business process ID in the business process ID column. The version value column stores the version value of the task. It is noted that the content of each column is described later.

FIG. 18 is a diagram illustrating one example of the task history information table T4 in FIG. 2. In the first embodiment of the present invention, the task history information table T4 is one example of a fourth table to store and correlate the task ID and the version value of the task, and the history of the task. The task history information table T4 includes a history ID column, the task ID column, the version value column, a history column, and the miscellaneous column. The history ID column stores the ID that identifies the history information of the task, such as the start date of execution of the task and the finish date of the execution of the task. The task ID column stores the corresponding ID of the task. The version value column stores the version value of the task, and the history column stores the history information of the task, and the miscellaneous column stores various information associated with the history. Hereinafter, the history information is appropriately referred to as history. It is noted that the content of each column is described later.

(Generation of Table and UI Screen)

The processing of generating the process information table T1, the task information table T2, the correlation information table T3, and the task history information table T4 will be described referring to FIGS. 2, 5 to 11, and 15 to 18. In the description below, the management apparatus 2 carries out the processing of generating the process information table T1, the task information table T2, the correlation information table T3, and the task history information table T4, in response to the various manipulations described in FIGS. 5 to 11.

The administrator inputs the name of the business process and the name of the process initiator on the business process generation screen U1 in FIG. 5 and downwardly pushes the save button. Incidentally, “initial research report” is inputted as the name of the business process, and “AAA” is inputted as the name of the process initiator. The input/output control unit 151 of the first terminal apparatus 1_1 transmits the control commands corresponding to the input manipulation and the downwardly-pushing manipulation to the overall management unit 221 of the management apparatus 2. The control commands include the name of the business process and the name of the process initiator to be inputted.

The overall management unit 221 transmits the control commands to the business process control unit 222. When the business process control unit 222 receives the control commands, the business process control unit 222 generates the business process ID and stores the business process ID in the business process ID column in the process information table T1 in FIG. 15.

Now, the business process control unit 222 generates “11” as the business process ID and stores “11” in the business process ID column in the process information table T1. Subsequently, the business process control unit 222 stores “initial research report” as the name of the business process contained in the control commands, in the name column corresponding to the business process ID, and stores “AAA” as the name of the process initiator contained in the control commands, in the process initiator column corresponding to the business process ID. The business process control unit 222 stores “non-start” in the state column corresponding to the business process ID. Simultaneously, the overall management unit 221 generates the display screen data for the business process, which includes the content in the name column, the state column, and the process initiator column of the process information table T1 in FIG. 15 corresponding to the business process ID and transmits the display screen data for the business process to the input/output control unit 151 of the first terminal apparatus 1_1.

When the input/output control unit 151 receives the display screen data for the business process, the input/output control unit 151 displays the business process display screen U2, as is illustrated in FIG. 6. The business process display screen U2 displays “11” as the business process ID, “initial research report” as the name of the business process to be inputted, and “AAA” as the name of the process initiator.

As is described in FIG. 6, the administrator inputs the name of the task and the name of the executor on the task generation screen U21 in FIG. 6 and clicks the generation button. Incidentally, “research planning” is inputted as the name of the task, and “E” is inputted as the name of the executor. The input/output control unit 151 of the first terminal apparatus 1_1 transmits the control commands corresponding to the input manipulation and the downwardly-pushing manipulation to the overall management unit 221 of the management apparatus 2. The control commands include the name of the task, the name of the executor, to be inputted, and the business process ID to which the task belongs.

When the overall management unit 221 receives the control commands, the overall management unit 221 transmits the control commands to the task control unit 223. When the task control unit 223 receives the control commands, the task control unit 223 generates the task ID and stores the task ID in the task ID column of the task information table T2 in FIG. 16. Incidentally, the business process control unit 222 generates “14” as the task ID and stores “14” in the task ID column of the task information table T2. Subsequently, the task control unit 223 stores “research planning” as the name of the task contained in the control commands, in the name column corresponding to the task ID and stores “E” as the name of the executor contained in the control commands, in the executor column corresponding to the task ID. Further, the task control unit 223 stores “non-start” as the task state in the state column corresponding to the task ID and stores “1” as the version value in the version value column corresponding to the task ID.

Further, the task control unit 223 stores “11” as the ID of business process to which “research planning” task belongs and “14” as the ID of the “research planning” task, which are contained in the control commands, respectively in the business process ID column and in the task ID column of the correlation information table T3 in FIG. 17. Then, the task control unit 223 stores “1” as the version value of the task in the version value column corresponding to the task ID.

The overall management unit 221 transmits the display screen data for the business process, which includes the content in the name column, the state column, the executor column, and the comment column of the task information table T2 in FIG. 16 corresponding to the task ID, to the input/output control unit 151 of the first terminal apparatus 1_1. When the input/output control unit 151 of the first terminal apparatus 1_1 receives the display screen data for the business process, the input/output control unit 151 displays the business process display screen U3, as is illustrated in FIG. 7. The business process display screen U3 displays “14” as the task ID in the task ID column, the name of the task to be inputted in the name column, “E” as the name of the executor in the executor column, and “non-start” in the state column, in the task list display column R4.

Further, as is described in FIGS. 6 and 7, the administrator sequentially carries out the manipulation of instructions for generation concerning the tasks. In FIGS. 6 and 7, the administrator carries out the manipulation of instructions for generation concerning “research” task, “generation of material 1” task, and “review” task. In this case, the administrator respectively inputs the “A”, “A”, and “B” as the executors and downwardly pushes the generation button. Further, as is described in FIG. 7, as the subtask of “research”, the administrator inputs “A-company research” and “B-company research” as the name of the task, and “A” and “B” as the name of the executor and downwardly pushes the generation button.

The input/output control unit 151 of the first terminal apparatus 1_1 transmits the control commands corresponding to the input manipulation and the downwardly-pushing manipulation to the overall management unit 221 of the management apparatus 2. In the case of the control commands corresponding to the input manipulation and the downwardly-pushing manipulation of subtasks, the control commands include specific information of the main task to which the subtasks belong, in addition to the name of the task, the name of the executor, to be inputted, and specific information on the business process to which the task belongs (for example, business process ID). For example, the specific information on the main task includes the ID of the main task.

When the task control unit 223 in FIG. 2 receives the control commands, the task control unit 223 generates the task ID and additionally updates the task information table T2 in FIG. 16. The task control unit 223 stores “15” as the ID of “research” task, “16” as the ID of “generation of material 1” task, and “17” as the ID of “review” task, which have been generated, in the ID columns of the task information table T2. Further, the task control unit 223 stores “18” as the ID of “A-company research” task and “19” as the ID of “B-company research” task, which are the subtasks of “research” task and disposed below the line of “15” of the ID of “research” task in the task information table T2. The task control unit 223 stores “non-start” in the state column and “1” as the version value in the version value column, corresponding to each task ID. Further, the business process control unit 222 stores “A” in the executor columns corresponding to the task IDs “15” “16” “18”, and “19” and “B” in the executor column corresponding to the task ID “17”. Although not shown, the task control unit 223 stores the correlation between the main task ID and the subtask ID in the storage device 25.

When the task control unit 223 receives the control commands, the task control unit 223 additionally updates the correlation information table T3 in FIG. 17. The task control unit 223 stores the above-mentioned task IDs “15” “18′19”, and “16” in the task ID columns. The task control unit 223 stores “11” as the ID of business process to which the task identified by the task ID belongs, in the business process ID column corresponding to the task ID and “1” as the version value in the version value column corresponding to the task ID.

The overall management unit 221 transmits the display screen data for the business process, which includes the content in the name column, the state column, the executor column, and the comment column of the task information table T2 in FIG. 16 corresponding to the task ID newly generated, to the input/output control unit 151 of the first terminal apparatus 1_1. When the input/output control unit 151 of the first terminal apparatus 1_1 receives the display screen data for the business process, the input/output control unit 151 displays the business process display screen U3, as is illustrated in FIG. 7. The business process display screen U3 displays the task IDs “15” “18” “19” (not shown in FIG. 7) “16”, and “17” in the task ID columns and “research” “A-company research” “B-company research” (not shown in FIG. 7) “generation of material 1”, and “review” as the name of the task corresponding to each ID in the name columns, in the task list display column R4. Further, the business process display screen U3 displays “A” “A” “A” (not shown in FIG. 7) “A”, and “B” as the name of the executor corresponding to each ID in the executor columns in the task list display column R4 and “non-start” as the task state corresponding to each ID in the state columns in the task list display column R4.

As is described in FIG. 7, when the administrator starts “research planning”, which is the first task in the business process of “initial research report”, the manipulation concerning the start instruction is carried out in the first terminal apparatus 1_1. The input/output control unit 151 of the first terminal apparatus 1_1 transmits the control command corresponding to the manipulation concerning the start instruction to the overall management unit 221 of the management apparatus 2. In response to the control command, the overall management unit 221 instructs the business process control unit 222 to update the process information table T1 corresponding to the manipulation concerning the start instruction and instructs the task control unit 223 to update the task information table T2 and the task history information table T4 corresponding to the manipulation concerning the start instruction. The control command represents a control command indicating that the manipulation concerning the start instruction for “research planning”, which is the first task in the business process of “initial research report”, is carried out. The control command includes “11” as the ID of “initial research report”, which is the business process to be started.

When the business process control unit 222 receives the control command, the business process control unit 222 changes the process state in the state column, corresponding to the business process of “initial research report”, to “executing” (see “non-start” “executing”) in the process information table T1 in FIG. 15. When the task control unit 223 receives the control command, the task control unit 223 retrieves “14” that is the top task ID in the correlation information table T3 in FIG. 17 and that corresponds to the “11”, which is the business process ID of “initial research report”. Then, the task control unit 223 stores “executing” in the state column corresponding to the task ID “14” to be retrieved in the task information table T2 in FIG. 16 (see “non-start” “executing”).

Further, the task control unit 223 newly generates a history ID and stores the history ID in the history ID column in the task history information table T4 in FIG. 18. Then, the business process control unit 222 stores the task ID “14” of “research planning” task being executed in the task ID column corresponding to the history ID and stores “1” as the version value of the task in the version value column. Further, the business process control unit 222 stores the character string “start” in the history column corresponding to the history ID, along with the date (years, months, and dates) and time (hours, minutes, and seconds), when the above-mentioned control command is received. For example, the date and time is exemplified by “yyyy1/mm1/dd1 hh1:mm1:ss1”, and “yyyy/mm/dd” represents years, months, and dates, and “hh:mm:ss” represents hours, minutes, and seconds. Hereinafter, years, months, dates, hours, minutes, and seconds, which are stored in the history column, are appropriately referred to as date and time.

Next, as is described in FIG. 8, the administrator inputs the name of the business process and the name of the process initiator on the business process generation screen U4 in FIG. 8 and downwardly pushes the generation button. Incidentally, “second research report” is inputted as the name of the business process, and “BBB” is inputted as the name of the process initiator.

Then, as is described in FIG. 15, when the business process control unit 222 receives the control command from the overall management unit 221, the business process control unit 222 generates the business process ID and stores the business process ID in the business process ID column in the process information table T1 in FIG. 15. Herein, the business process control unit 222 generates “22” as the business process ID and stores “22” in the business process ID column in the process information table T1. Next, the business process control unit 222 stores “second research report” as the name of the business process contained in the control command, in the name column corresponding to the business process ID and stores “BBB” as the name of the process initiator contained in the control command, in the process initiator column corresponding to the business process ID. The business process control unit 222 stores “non-start” in the state column corresponding to the business process ID.

Further, as is described in FIG. 9, the administrator sequentially carries out the manipulation of instructions for generation concerning the tasks. In FIG. 9, the administrator carries out the manipulation of instructions for generation concerning “generation of material 2” task and “review” task. In this case, the administrator inputs “C” and “B” as the executors and downwardly pushes the generation button.

When the task control unit 223 in FIG. 2 receives the control command from the overall management unit 221, the task control unit 223 additionally updates the task information table T2 in FIG. 16. The task control unit 223 stores “25” as the task ID of “generation of material 2” task and “26” as the task ID of “review” task, in the task ID columns in the task information table T2. The task control unit 223 stores “non-start” in the state column and “1” in the version value column, corresponding to each task ID in the task information table T2. Further, the task control unit 223 stores “C” and “B” in the executor columns respectively corresponding to the task IDs “25” and “26”.

Also, when the task control unit 223 receives the control command, the task control unit 223 additionally updates the correlation information table T3 in FIG. 17. The task control unit 223 stores the above-mentioned task IDs “25” and “26” in the task ID columns. The task control unit 223 stores “22” as the ID of the business process to which the task identified by the task ID belongs, in the business process ID column corresponding to the task ID and stores “1” in the version value column corresponding to the task ID.

Next, as is described in FIG. 11, the administrator instructs the first terminal apparatus 1_1 to carry out the manipulation of the completion setting for “research planning” task. The input/output control unit 151 of the first terminal apparatus 1_1 transmits the control command corresponding to the manipulation of the instructions for the completion setting to the overall management unit 221 of the management apparatus 2. The control command includes the ID of the task subject to the manipulation of the instructions for the completion setting, the ID of the business process to which the task belongs, and information indicating that the manipulation of the instructions for the completion setting is carried out. When the overall management unit 221 receives the control command, the overall management unit 221 transmits the control command to the task control unit 223.

In the example of FIG. 11, the control command includes the task ID “14”, the business process ID “11”, and the information indicating that the manipulation of the instructions for the completion setting is carried out.

When the task control unit 223 receives the control command, the task control unit 223 stores “completion” in the state column corresponding to the task ID “14” in the task information table T2 in FIG. 16 (see “executing” “completion”). Subsequently, the task control unit 223 changes the states of “research” task, which is the following task subsequent to “research planning” task whose task ID is “14”, to “executing” and changes the states of “A-company research” task to “executing” (see “non-start” “executing”). The following task is a task specified by a task ID, which is disposed below the task ID stored in the task ID column corresponding to “executing” in the state column at present. When the specified task is the main task, the first subtask of the main task is also the following task.

The task control unit 223 newly generates a history ID “31” and stores the history ID “31” in the history ID column in the task history information table T4 in FIG. 18. Then, the task control unit 223 stores the task ID “14” of “research planning” task to be completed, in the task ID column corresponding to the history ID and stores “1” as the version value of the task in the version value column. Further, the task control unit 223, for example, stores a character string “completion” in the history column corresponding to the history ID, along with the date and time when the above-mentioned control command is received. For example, the date and time is exemplified as “yyyy2/mm2/dd2 hh2:mm2:ss2”.

Then, the task control unit 223 generates history IDs “32” and “33” of the tasks in order to specify the history of “research” task, which is the following task, and the history of “A-company research” task, and stores the history IDs “32” and “33” in the history ID columns in the task history information table T4. The task control unit 223 stores “15” as the ID of “research” task, which is the following task, and “18” as the ID of “A-company research” task in the task ID columns corresponding to the history IDs “32” and “33” and stores 1″ as the version value of the task in the version value column. Further, the task control unit 223 stores a character string “start” in the history column corresponding to the history ID, for example, along with the date and time when the above-mentioned control command is received. For example, the date and time is exemplified as “yyyy2/mm2/dd2 hh2:mm2:ss2”.

Next, as is described in the comment compilation screen U72 of FIG. 11, “A” of the executor of “A-company research” task executes the task and inputs comments associated with the operational content of the task.

“A” of the executor inputs comments in the text box for inputting comments, inputs “A” as the name of the executor in the text box for inputting the name of comment writer, on the comment compilation screen U72, and downwardly pushes the save button.

The input/output control unit 151 of the first terminal apparatus 1_1 transmits the control commands corresponding to the input manipulation and the downwardly-pushing manipulation to the overall management unit 221 of the management apparatus 2. The control commands include a task to be inputted in terms of comments, in other words, the ID of the task that the executor selects from the task list of the business process display screen U7 in FIG. 11, comments and a person who makes the comments that are inputted on the comment compilation screen U72. Further, the control commands include the ID of the business process to which the task belongs. In the example of FIG. 11, the control commands include the task ID “18”, the comment “CMT”, the comment writer “A”, and the business process ID “11”.

When the overall management unit 221 receives the control commands, the overall management unit 221 transmits the control commands to the task control unit 223. When the task control unit 223 receives the control commands, the task control unit 223 stores the comments and the person who makes the comments, in the comment column corresponding to the task ID contained in the control command, in the task information table T2 in FIG. 16. In the case of the task information table T2, the task control unit 223 stores “CMT” in the comment column corresponding to the task ID “18”. Incidentally, the illustration of the person who makes the comments is omitted.

It is noted that the task control unit 223 may newly generate a history ID and store the history ID in the history ID column in the task history information table T4 in FIG. 18. Then, the task control unit 223 may store the task ID contained in the control command in the task ID column in the task history information table T4 and may store the date and time when the comments are received in the history column, and for example, may store “CMT input” after the date and time. Then, the task control unit 223 may retrieve the version value of the task specified by the business process ID and the task ID contained in the control command from the correlation information table T3 in FIG. 17 and may store the version value in the version value column in the task history information table T4 in FIG. 18.

Next, as is described in FIG. 11, the administrator instructs the first terminal apparatus 1_1 to carry out the manipulation of the completion setting for “A-company research” task. The input/output control unit 151 of the first terminal apparatus 1_1 transmits the control command corresponding to the manipulation of the instructions for the completion setting to the overall management unit 221 of the management apparatus 2. In the example of FIG. 11, the control command includes the task ID “18”, the business process ID “11”, and the information indicating that the manipulation of the instructions for the completion setting is carried out.

When the task control unit 223 receives the control command from the overall management unit 221, the task control unit 223 stores “completion” in the state column corresponding to the task ID “18” in the task information table T2 in FIG. 16 (see “executing” “completion”). Next, the task control unit 223 changes the states of “B-company research” task, which is the following task subsequent to “A-company research” task whose task ID is “18”, to “executing” (see “non-start” “executing”).

The task control unit 223 newly generates a history ID “34” and stores the history ID “34” in the history ID column in the task history information table T4 in FIG. 18. The business process control unit 222 stores the task ID “18” of “A-company research” task to be completed, in the task ID column corresponding to the history ID and stores “1” as the version value of the task in the version value column. Further, the business process control unit 222 stores the character string “completion” in the history column corresponding to the history ID, for example, along with the date and time when the above-mentioned control command is received. For example, the date and time is exemplified as “yyyy3/mm3/dd3 hh3:mm3:ss3”.

Then, the business process control unit 222 generates a history ID “35” of the task in order to specify the history of “B-company research” task, which is the following task, and stores the history ID “35” in the history ID column in the task history information table T4. The business process control unit 222 stores “19” as the task ID of “B-company research” task (the following task) being executed, in the task ID column corresponding to the history ID “35” and stores “1” as the version value of the task in the version value column. Further, the business process control unit 222 stores the character string “start” in the history column corresponding to the history ID, for example, along with the date and time when the above-mentioned control command is received. For example, the date and time is exemplified as “yyyy3/mm3/dd3 hh3:mm3:ss3”.

(Task Transfer Processing)

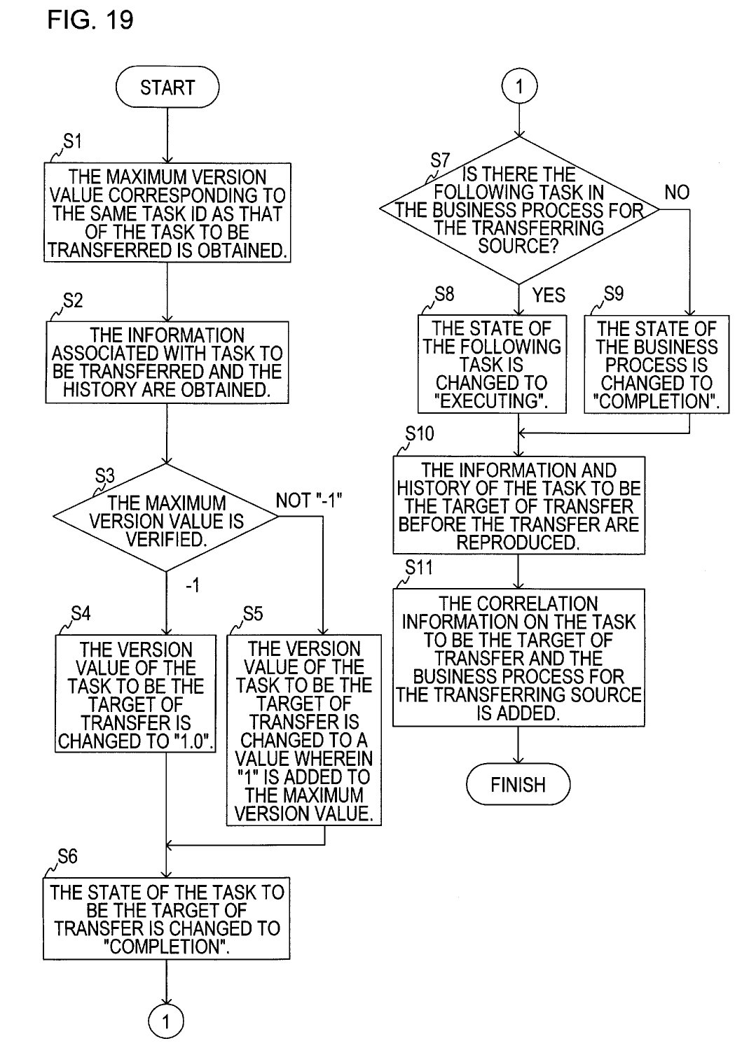

The flow of task transfer processing that the management apparatus 2 executes will be described referring to FIGS. 2, 11, 15 to 18, based on FIGS. 19 to 22.

FIG. 19 is a flowchart illustrating one example of the flow of task transfer processing that the management apparatus 2 executes.

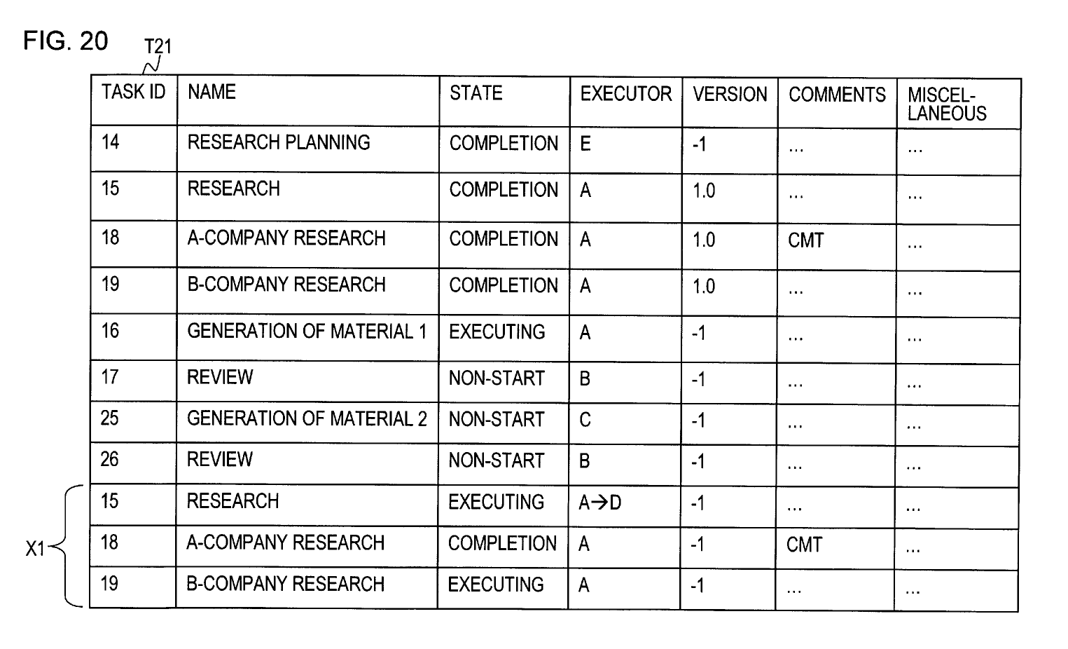

FIG. 20 is a diagram illustrating one example of a state where the task information table T2 in FIG. 16 is updated. “A D” in the executor column in FIG. 20 schematically illustrates that the executor is changed from “A” to “D”. Actually, any one of “A” or “D” is stored.

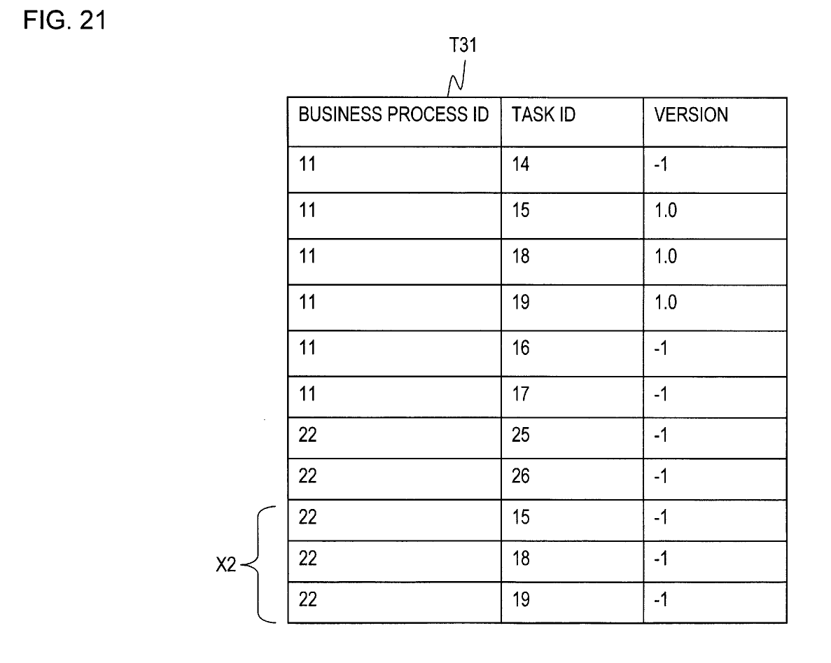

FIG. 21 is a diagram illustrating one example of a state where the correlation information table T3 in FIG. 17 is updated.

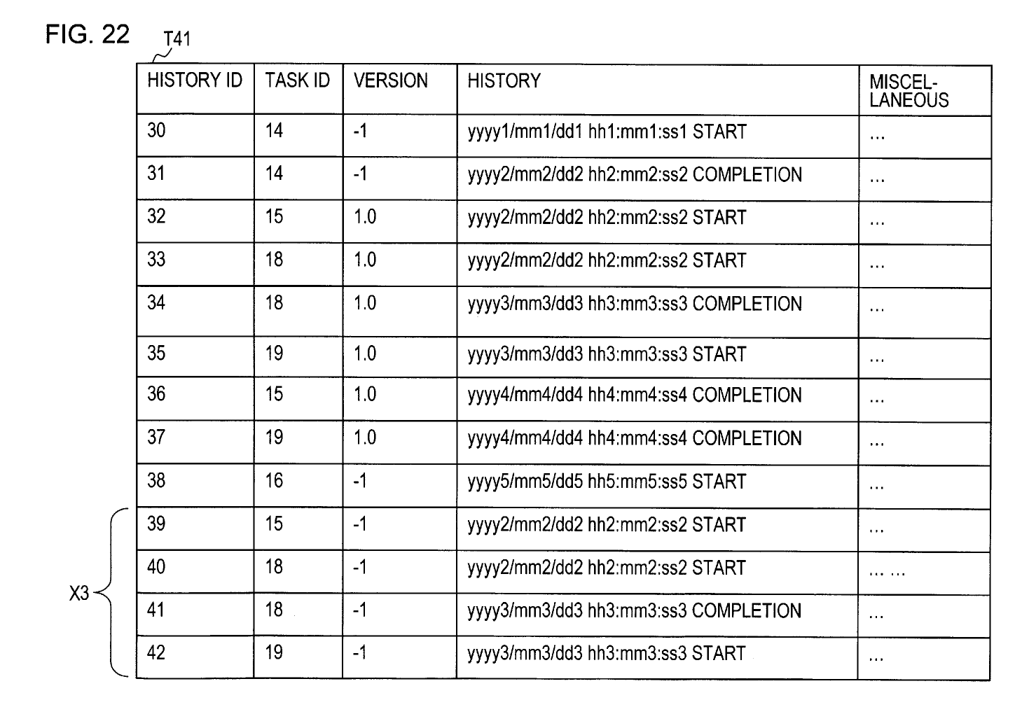

FIG. 22 is a diagram illustrating one example of a state where the task history information table T4 in FIG. 18 is updated.

It is assumed that the following processing is carried out before the execution of the processing in FIG. 19. That is, as is described in FIG. 11, the administrator selects the task to be the target of transfer from the task list and selects “transfer” from the drop-down list U71 that is displayed by carrying out the manipulation of drop-down list display instruction. Further, the administrator downwardly pushes “transfer button” on the retrieval result screen U73 that is displayed by the select manipulation. The input/output control unit 151 of the first terminal apparatus 1_1 transmits the control command corresponding to the downwardly-pushing manipulation to the overall management unit 221 of the management apparatus 2.

The control command is one example of a task transfer instruction command inputted in the management apparatus 2 as the instructions for transferring tasks. The control command includes a business process ID of the business process for the transfer source, the task ID of the task to be the target of transfer, and the business process ID of the business process for the transfer destination. In the example of FIG. 11, the control command includes “15” as the task ID of the task to be the target of transfer, “11” as the business process ID of the business process for the transfer source, and “22” as the business process ID of the business process for the transfer destination for the task.

When the overall management unit 221 of the management apparatus 2 receives the control command, the overall management unit 221 transmits the control command to the task transfer control unit 224. When the task transfer control unit 224 receives the control command, as the response to the instructions for transferring the task, the task transfer control unit 224 sets the version value of the task to be the target of transfer in the business process for the transfer destination to a first value and changes the version value of the task to be the target of transfer in the business process for the transfer source to a second value corresponding to the number of times regarding the transfer. For example, the first value is “1”. Hereinafter, specific processing will be described referring to FIG. 19.

Step S1: The task transfer control unit 224 obtains the maximum version value corresponding to the same task ID as the task ID of the task to be the target of transfer and contained in the control command from the correlation information table T3 in FIG. 17. When the task identified by the task ID is the main task, the subtasks of the main task also correspond to the task to be the target of transfer.

In the example described above, “research” task to be the target of transfer is the main task, and the subtasks of the main task are “A-company research” task and “B-company research” task, and the IDs of the subtasks are respectively “18” and “19”. Accordingly, the task transfer control unit 224 obtains the maximum version value “1” corresponding to the task IDs “15” “18”, and “19” from the correlation information table T3 in FIG. 17.

Step S2: The task transfer control unit 224 obtains information associated with the task to be the target of transfer from the task information table T2 in FIG. 16 and obtains task history from the task history information table T4 in FIG. 18.

In the example described above, the task transfer control unit 224 obtains the task name, the state, the executor, the version value, comments, each of which is information associated with the IDs “15” “18”, and “19” of the tasks to be transferred. Further, the task transfer control unit 224 obtains the task history of the IDs “15” “18”, and “19” of the tasks to be transferred from the task history information table T4 in FIG. 18.

Step S3: The task transfer control unit 224 determines whether the maximum version value obtained in the step S1 is “1”. When the maximum version value is “1” (Step S3/“1”), the process goes to a step S4. When the maximum version value is not “1” (Step S3/not “1”), the process goes to a step S5.

Step S4: The task transfer control unit 224 changes the version values of the task to be the target of transfer in the task information table T2 in FIG. 16, in the correlation information table T3 in FIG. 17, and in the task history information table T4 in FIG. 18 to “1.0” corresponding to the number of times regarding the transfer.

In the example described above, the task transfer control unit 224 changes the version values of the IDs “15” “18”, and “19” of the tasks to be transferred to “1.0” as illustrated in a task information table T21 in FIG. 20, in a correlation information table T31 in FIG. 21, and in a task history information table T41 in FIG. 22.

Step S5: The task transfer control unit 224 changes the version values of the tasks to be transferred in the task information table T2 in FIG. 16, in the correlation information table T3 in FIG. 17, and in the task history information table T4 in FIG. 18 to a value in which “1” is added (+1) to the maximum version value obtained in the step S1. This value after the change is a value corresponding to the number of times regarding the transfer.

Step S6: The task transfer control unit 224 changes the states of the task to be the target of transfer in the task information table T2 in FIG. 16 to “completion”. Further, the task transfer control unit 224 newly generates a history ID corresponding to the task to be the target of transfer, stores the history ID in the history ID column in the task history information table T4 in FIG. 18, and stores the ID of the task in the task ID column. For example, the task transfer control unit 224 stores the character string “completion” in the history column corresponding to the history ID, along with the date and time when the history ID is generated and stores “1.0” in the version value column corresponding to the history ID. When the state of the task to be the target of transfer has already led to “completion”, the task transfer control unit 224 does not generate the history ID.

In the example described above, the task transfer control unit 224 sets the states of the IDs “15” “18”, and “19” of the tasks to be transferred to “completion” as illustrated in the task information table T21 in FIG. 20. Further, as illustrated in the task history information table T41 in FIG. 22, the task transfer control unit 224 stores the history IDs “36” and “37” corresponding to the IDs “15” and “19” of the tasks to be transferred, in the history ID columns, stores the task IDs “15” and “19” in the task ID columns, stores the version value “1.0” in the version value column, and stores the date and time “yyyy4/mm4/dd4 hh4:mm4:ss4” and “completion” in the history column.

Step S7: The task transfer control unit 224 determines the presence or absence of the task to be executed subsequent to the task to be the target of transfer in the business process for the transfer source. When the task to be the target of transfer is the main task, the tasks that are not the subtasks of the main task are tasks subsequent to the task to be the target of transfer.

When there is the following task (Step S7/YES), the process goes to a step S8. When there is no following task (Step S7/NO), the process goes to a step S9.

In the example described above, with reference to the task information table T2 in FIG. 16, the task to be the target of transfer is “research”, and the task is the main task. Accordingly, there is “generation of material 1” task to be followed, the process goes to the step S8. In contrast, when the task to be the target of transfer is “review” task, there is no task to be followed, and the process goes to the step S9.

Step S8: The task transfer control unit 224 changes the states of the following task to “executing” in the task information table T2 in FIG. 16. The task transfer control unit 224 newly generates a history ID corresponding to the following task in the task history information table T4 in FIG. 18, stores the history ID in the history ID column in the task history information table T4 in FIG. 18, and stores the ID of the following task in the task ID column. The task transfer control unit 224 stores the character string “executing” in the history column corresponding to the history ID, along with the date and time when the history ID is generated and stores “1” in the version value column corresponding to the history ID.

In the example described above, the task transfer control unit 224 changes the states of the following task, whose ID is “16”, to “executing” in the task information table T21 in FIG. 20. Further, as illustrated in the task history information table T41 in FIG. 22, the task transfer control unit 224 stores the history ID “38” corresponding to the ID “16” of the following task (“generation of material 1”) in the history ID column, stores the task ID “16” in the task ID column, stores the version value “1” in the version value column, and stores the date and time “yyyy5/mm5/dd5 hh5:mm5:ss5” and the character string “start” in the history column.

Step S9: The task transfer control unit 224 changes the states of the business process for the transfer source to “completion”. For example, when the task to be the target of transfer is “review” task, the task transfer control unit 224 changes the states to “completion” in the state column corresponding to the business process ID “11” that identifies “initial research report”, which is the business process for the transfer source, in the process information table T1 in FIG. 15.

Step S10: The task transfer control unit 224 obtains the information (task information) of the task to be the target of transfer before the transfer from the task information table T2 in FIG. 16, obtains the ID, version value, and history of the task to be the target of transfer before the transfer from the task history information table T4 in FIG. 18, and reproduces the data to be obtained in another columns of each table.

In the example described above, in the task information table T2 in FIG. 16, the information of the task to be the target of transfer before the transfer includes the IDs “15” “18”, and “19” of the task, the names “research”, “A-company research”, “B-company research” of the task, the states “executing”, “completion”, and “executing” of the task, the version value “1”. Further, the information of the task includes “CMT” as the comments of “A-company research” task. The task transfer control unit 224 obtains the names, states, executors, version values, comments of the task IDs “15” “18”, “19” from the task information table T2 in FIG. 16 and adds these data to be displayed on the task information table T21 in FIG. 20 (see a reference number X1).

Further, in the example described above, in the task history information table T4 in FIG. 18, the IDs of the tasks to be transferred before the transfer are “15” “18” “18”, and “19”, and the version values of the tasks are 1″. The history of the tasks includes “yyyy2/mm2/dd2 hh2:mm2:ss2 start”, “yyyy2/mm2/dd2 hh2:mm2:ss2 start”, “yyyy3/mm3/dd3 hh3:mm3:ss3 completion”, and “yyyy3/mm3/dd3 hh3:mm3:ss3 start”

The task transfer control unit 224 generates the history IDs corresponding to the number of IDs of the tasks before the transfer and store the history IDs in the history columns, as illustrated in the task history information table T41 in FIG. 22. In the example described above, the number of IDs of the tasks is “4”, so that the task transfer control unit 224 generates the history IDs “39” to “42” and stores the history IDs in the history ID columns in the task history information table T41. Then, the task transfer control unit 224 stores the IDs of the tasks, the version values of the tasks, and the history of the tasks, respectively in the task ID columns, in the version value columns, and in the history columns of the task history information table T41 (see a reference number X3).

Step S11: The task transfer control unit 224 adds correlation information (correlation) between the task to be the target of transfer and the business process for the transfer destination. Specifically, the task transfer control unit 224 adds the ID of the task to be the target of transfer to the task ID column in the correlation information table T3 in FIG. 17, stores the ID of the business process for the transfer destination in the business process ID column corresponding to the task ID to be added, and stores “1” in the version value column corresponding to the task ID to be added.

In the example described above, as illustrated in the correlation information table T31 in FIG. 21, the task transfer control unit 224 stores the task IDs “15” “18”, and “19” of the tasks to be transferred in the task ID columns and stores the ID “22” of “second research report”, which is the business process for the transfer destination, in the business process ID columns corresponding to the task IDs “15” “18”, and “19”. The task transfer control unit 224 stores “1” in the version value columns corresponding to the task IDs “15” “18”, and “19” (see a reference number X2).

The summary of the content of processing according to the task transfer control unit 224 described in FIG. 19 is as follows. That is, as is described in the steps S4 and S5, the task transfer control unit 224 changes the version value of the task to be the target of transfer to the second value in the task information table T2 in FIG. 16. In the correlation information table T3 in FIG. 17, the task transfer control unit 224 changes the version value, corresponding to the task ID of the task to be the target of transfer and the business process ID of the business process for the transfer source, to the second value.

As is described in the step S10, in the task information table T2 in FIG. 16, the task transfer control unit 224 stores the reproductions of the task ID of the task to be the target of transfer before the transfer and the information associated with the task and stores the version value “1” corresponding to the reproduced information associated with the task. Further, in the task history information table T4 in FIG. 18, the task transfer control unit 224 store the reproductions of the task ID and history of the task to be the target of transfer and stores the version value “1” corresponding to the reproduced history.

Further, as is described in the step S11, in the correlation information table T3 in FIG. 17, the task transfer control unit 224 stores and correlates the task ID of the task to be the target of transfer and the business process ID of the business process for the transfer destination, and the version value “1”.

As is described in the step S10, according to the processing in FIG. 19, the management apparatus 2 can manage the task to be the target of transfer in a manner as to correlate the business process for the transfer source with the business process for the transfer destination based on the correlation information table T31 in FIG. 21. As a result, even when the task is transferred between the business processes, the management apparatus 2 can carry out the control that the business process for the transfer destination automatically takes over the task of the business process for the transfer source and information associated with the task.

Herein, the processing in the step S5 will be described. For example, the administrator instructs the management apparatus 2 to generate the third research report as the business process subsequent to the second research report, which is the business process. Then, “research” task in “second research report” is transferred to “third research report”. In this case, the task transfer control unit 224 obtains the version value “1” in the step S1 in FIG. 19. Then, the task transfer control unit 224 changes the version values of the task to be the target of transfer, in the task information table T2 in FIG. 16, in the correlation information table T3 in FIG. 17, and in the task history information table T4 in FIG. 18, to “2” wherein “1” is added to the maximum version value “1” obtained in the step S1.

Thus, the version value is changed corresponding to the number of times regarding the transfer. Accordingly, even when the task is transferred between the business processes, the history of the task for each business process can be managed.

(Display of Business Process List and Task List)

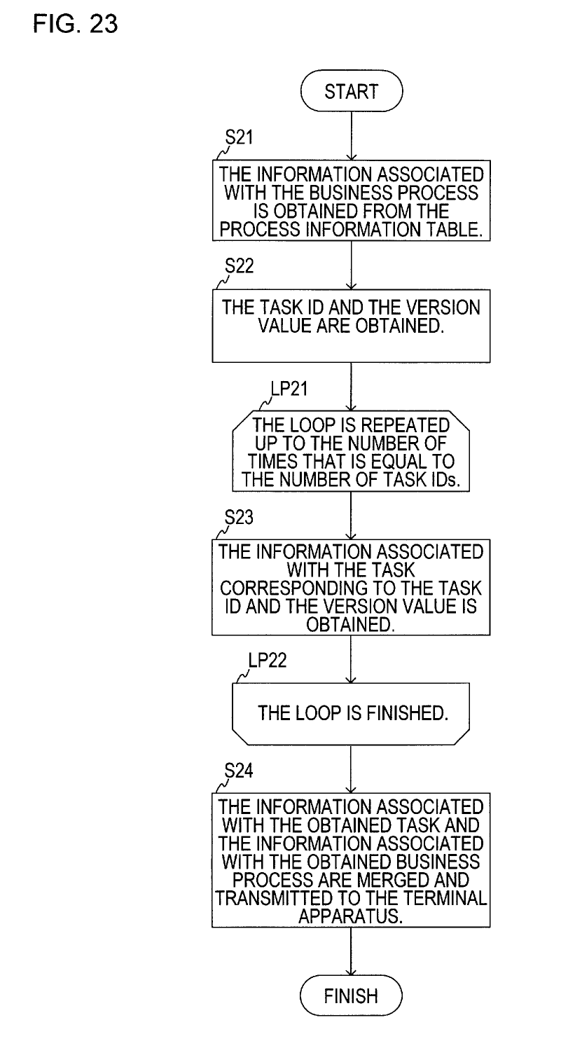

As is described in FIGS. 11 and 12, there will be described the processing with regards to the display of the business process list in the business process list display column R1 and the display of the task list in the task list display column R4 on the business process display screen, referring to FIGS. 11, 12, 15, 20, and 21, based on FIG. 23.

FIG. 23 is a flowchart illustrating one example of the flow of processing of displaying the business process list and the task list. Before the execution of the processing in FIG. 23, the management apparatus 2 executes the task transfer processing described in the flowchart of FIG. 19 and stores the task information table T21 in FIG. 20 and the correlation information table T31 in FIG. 21 in the storing device 14. Further, as is described in FIG. 11, it is assumed that the administrator selects “second research report” from the business process list on the business process display screen U7.

As a result, the input/output control unit 151 of the first terminal apparatus 1_1 transmits the control command corresponding to the select manipulation to the overall management unit 221 of the management apparatus 2. The control command is one example of a display instruction command of the business process to be displayed that includes the business process ID of the business process to be displayed. In other words, the control command includes the business process ID to be selected and information indicating the task list display. In the case of FIG. 11, the control command includes “22” as the business process ID.

When the overall management unit 221 of the management apparatus 2 receives the control command, the overall management unit 221 transmits the control command to the task transfer control unit 224. When the task transfer control unit 224 receives the control command, the task transfer control unit 224 executes the processing in FIG. 23.

Step S21: The business process control unit 222 obtains the information associated with the business process to be displayed from the process information table T1 in FIG. 15. The business process to be displayed is the selected business process.

Specifically, the business process control unit 222 obtains the name of business process, state, and process initiator corresponding to the business process ID contained in the control command, from the process information table T1 in FIG. 15. In the example described above, the business process control unit 222 obtains “second research report” as the name of the business process corresponding to the business process ID “22”, the state “non-start”, the process initiator “BBB”.

Step S22: The business process control unit 222 obtains the ID of the task in the business process to be displayed and the version value of the task, from the correlation information table T31 in FIG. 21. In the example described above, the business process control unit 222 obtains the IDs “15” “18” “19” “25”, and “26” of the tasks that belong to “second research report”, which is the business process specified by the business process ID “22”, and obtains the version value “1”.

Step S23: The business process control unit 222 obtains the information associated with the task in the business process to be displayed, corresponding to each task ID to be obtained and the version value, from the task information table T21 in FIG. 20. The business process control unit 222 repeats the acquisition processing up to the number of times that is equal to the number of the task IDs to be obtained (see Loop LP21 to Loop LP22). In the example described above, the task IDs to be obtained are “15” “18” “19” “25”, and “26′, and the version value to be obtained is 1”. Accordingly, the business process control unit 222 obtains the task names “research”, “A-company research”, “B-company research”, “generation of material 2”, and “review”, as the information associated with the task, and respectively “executing”, “completion”, “executing”, “non-start”, and “non-start”, as the states, from the task information table T21 in FIG. 20. The business process control unit 222 obtains the process initiators “A” “A” “A” “C”, and “B” from the task information table T21 and the comments “CMT” as the “A-company research” task as the information associated with the task, from the task information table T21.

Step S24: The business process control unit 222 merges the obtained task IDs and the obtained information associated with the task and the obtained information associated with the business process, which is transmitted to the first terminal apparatus 1_1. Specifically, the business process control unit 222 transmits the obtained task IDs and the obtained information associated with the task and the obtained information associated with the business process to the overall management unit 221. The overall management unit 221 generates the screen data for the business process list and the screen data for the task list, based on the task IDs and the information associated with the task and the information associated with the business process, and transmits the screen data to the first terminal apparatus 1_1. The screen data is one example of date to be displayed with respect to the obtained information associated with the task and the obtained information associated with the business process.

When the input/output control unit 151 of the first terminal apparatus 1_1 receives the screen data, the input/output control unit 151 displays a business process list column and a task list column of the business process screen based on the screen data. In the example described above, as illustrated in the business process list display column R1 and the task list display column R4 of the business process display screen U8 in FIG. 12, the business process list and the task list are displayed.

Further, the processing in FIG. 23 is executed in various opportunities. For example, in FIG. 11, the input/output control unit 151 of the first terminal apparatus 1_1 displays the drop-down list U71 in response to the select manipulation of the task list to be transferred, according to the administrator. Then, when the administrator selects “transfer” from among the items of the drop-down list U71, the input/output control unit 151 of the first terminal apparatus 1_1 transmits the control command to the overall management unit 221 of the management apparatus 2. The control command includes the ID of the task to be the target of transfer, the ID of the business process to which the task to be the target of transfer belongs, and the information indicating that the manipulation of “transfer” selection is carried out. In the example of FIG. 11, the ID of the task to be the target of transfer is “15”, and the ID of the business process to which the task to be the target of transfer belongs is “11”.

When the overall management unit 221 receives the control command, the overall management unit 221 transmits the control command to the business process control unit 222. The business process control unit 222 retrieves the business process ID except the business process ID contained in the control command from the process information table T1 in FIG. 15, and executes the processing of the step S21 afterwards, assuming that the retrieved business process ID is the business process ID contained in the control command in the step S21 in FIG. 23. With regards to the execution of this processing, the task transfer processing has not been executed yet. Accordingly, in the step S22 in FIG. 23, the business process control unit 222 obtains the ID of the task of the business process specified by the retrieved business process ID and the version value of the task from the correlation information table T3 in FIG. 17. Then, in the step S23 in FIG. 23, the business process control unit 222 obtains the information associated with the task corresponding to the each task ID and the version value to be obtained, from the task information table T2 in FIG. 16. Next, in the step S24 in FIG. 23, the business process control unit 222 merges the obtained task IDs and the obtained information associated with the task and the obtained information associated with the business process and transmits the merged information to the first terminal apparatus 1_1. Specifically, the business process control unit 222 transmits the obtained task IDs and the obtained information associated with the task and the obtained information associated with the business process to the overall management unit 221. The overall management unit 221 generates the screen data for the business process list and the screen data for the task list, based on the task IDs and the information associated with the task and the information associated with the business process, and transmits the screen data to the first terminal apparatus 1_1.

When the input/output control unit 151 of the first terminal apparatus 1_1 receives the screen data, the input/output control unit 151 displays the screen illustrated on the retrieval result screen U73 in FIG. 11.

According to the processing described in FIG. 23, the management apparatus can provide the information on the business process and the information on the task in the business process for the administrator and the executor.

The procedure of displaying the task list in the task list display column R4 on the business process display screen U7 in FIG. 11 will be described. When the overall management unit 221 of the management apparatus 2 generates the screen data for displaying the task list in the business process for the transfer source, the overall management unit 221, for example, operates as follows.

For example, the overall management unit 221 generates the screen data based on the procedure regarding the line of the task IDs in the business process for a transfer source, that is, in such a manner that the information associated with the task is displayed from above to below in the task information table T21 in FIG. 20. In the example of FIG. 20, the overall management unit 221 generates the screen data in such a manner that the information associated with the task is displayed in the order of the task IDs “14” “15” “18” “19” “16”, and “17”.

In contrast, when the overall management unit 221 of the management apparatus 2 generates the screen data for displaying the task list in the business process for the transfer destination, the overall management unit 221, for example, operates as follows. For example, in the task information table T21 in FIG. 20, the overall management unit 221 operates in a manner that the information associated with the task is displayed on the upper side of the task list, as the numerical value of the ID of the task in the business process for the transfer destination is reduced. In the example of FIG. 20, the overall management unit 221 generates the screen data in a manner that the information associated with the task is displayed in the order of the task IDs “15” “18” “19” “25” and “26”.

(Task Association Information Change)

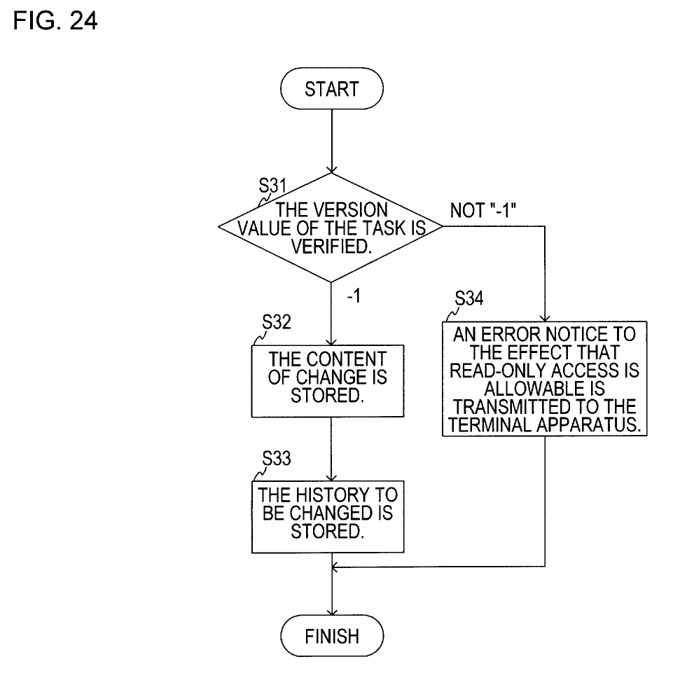

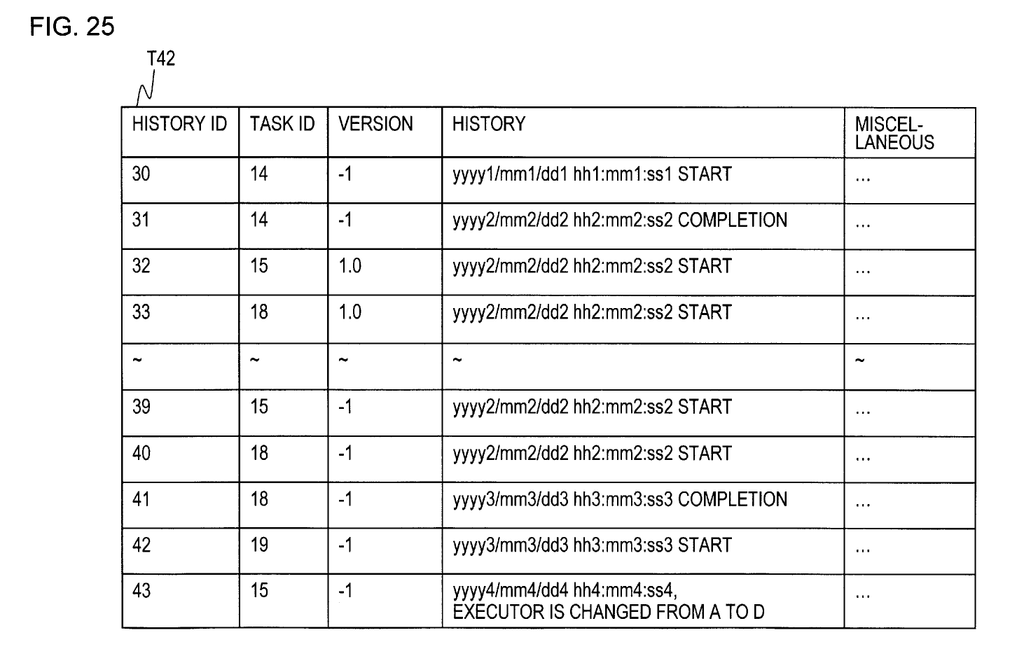

As is described in FIG. 13, the processing of changing the executors of the task or changing comments of the task, which is the information associated with the task, will be described referring to FIGS. 13, 20, and 21, based on FIGS. 24 and 25. Hereinafter, these changes are appropriately referred to as task association information change.

As a specific example, the change of the executors of the task is exemplified, but the change of comments of the task is also applied.

FIG. 24 is a flowchart illustrating one example of the flow of the processing of the task association information change.

FIG. 25 is a diagram illustrating one example of a state where the task history information table T41 in FIG. 22 is updated. It is noted that “˜” (wavy line) in the task history information table T42 represents that the lines of the history IDs “34” to “38” stored in the history ID columns in the task history information table T41 in FIG. 22 are omitted

It is assumed that the following processing is carried out before the execution of the processing in FIG. 24. That is, as is described in FIG. 13, the administrator selects the task which is a target of change of executors, from the task list on the business process display screen U9 in FIG. 13 and selects “executor change” from the drop-down list U91. As is described in FIG. 12, the administrator selects “second research report” from the business process list. When the administrator inputs “D” as the name of the executor after the change in the text box of the executor change column on the executor change screen U93 and downwardly pushes the save button, the input/output control unit 151 of the first terminal apparatus 1_1 transmits the control commands corresponding to the input manipulation and the downwardly-pushing manipulation to the overall management unit 221 of the management apparatus 2.

The control command is one example of a task change instruction command that includes the task ID of the task to be changed, the business process ID of the business process to which the task to be changed belongs, and the information associated with the task to be changed after the change. In the description below, the information associated with the task to be changed after the change is appropriately referred to as the content of change. In the example described above, the business process ID is “22”, and the task ID is “15”, and the content of change is the name of the executor to be inputted. The task to be changed is the selected task.

When the overall management unit 221 receives the control command, the overall management unit 221 transmits the control command to the task control unit 223. When the task control unit 223 receives the control command, the task control unit 223 executes the processing in FIG. 24.

Step S31: The task control unit 223 verifies (also referred to as “determine”) whether the version value of the selected task is “1”. When the version value of the selected task is “1”, the process goes to a step S32. When the version value of the selected task is not “1”, the process goes to a step S34.

Specifically, the task control unit 223 obtains the version value corresponding to the business process ID and the task ID contained in the control command, from the correlation information table T31 in FIG. 21. Then, the task control unit 223 verifies whether the obtained version value is “1”.

In the example described above, the version value corresponding to the business process ID “22” and the task ID “15” is “1”. Accordingly, the process goes to the step S32.

Step S32: The task control unit 223 stores the content of change. Specifically, in the task information table T21 in FIG. 20, the task control unit 223 changes the information associated with the task, corresponding to the task ID contained in the control command and the obtained version value “1”, to the content of change, which is the information associated with the task after the change. In the example described above, the task control unit 223 changes the executors, in the executor column corresponding to the task ID “15” and the version value “1”, into “D” (“A” “D”).

Step S33: The task control unit 223 stores the history of change. Specifically, the task control unit 223 newly generates a history ID, stores the history ID in the history ID column in a task history information table T42 in FIG. 25, stores the task ID contained in the control command in the task ID column corresponding to the history ID column, and stores the version value “1” in the version value column corresponding to the history ID column. Then, the task control unit 223, for example, stores the date and time when the history ID is generated, in the history column and store the content of change regarding the control command. In the example described above, as is described in FIG. 25, the history ID “43” to be generated is stored in the history ID column, and the task ID “15” is stored in the task ID column, and “yyyy4/mm4/dd4 hh4:mm4:ss4, Executor Change A D” is stored in the history column.

Step S34: The task control unit 223 transmits an error notice to the effect that read-only access is allowable, to the input/output control unit 151 of the first terminal apparatus 1_1. When the input/output control unit 151 receives the error notice, the input/output control unit 151 displays that read-only access is allowable, on the display device 121.

For example, the step S34 is executed in the following case. That is, the administrator selects the task which is a target of change of executors, from the task list on the business process display screen U10 in FIG. 14 and selects “executor change” from the drop-down list U101. As is described in FIG. 11, the administrator selects “initial research report” from the business process list.

When the administrator inputs “D” as the name of the executor after the change in the text box of the executor change column on the executor change screen (see FIG. 13) and downwardly pushes the save button, as is described above, the input/output control unit 151 transmits the control commands, including the task ID “15” to be selected and the business process ID 11” to be selected, to the overall management unit 221 of the management apparatus 2.

When the overall management unit 221 receives the control commands, the overall management unit 221 transmits the control commands to the task control unit 223. When the task control unit 223 receives the control commands, the task control unit 223 executes the processing in the step S31. In this case, the version value corresponding to the business process ID “11” and the task ID “15” contained in the control commands is “1.0” (not “1”). Accordingly, the process goes to the step S34. In this case, the manipulation of change is carried out for the content of the task of the business process for the transfer source that has already been transferred, so that the management apparatus 2 does not execute the processing of change.

According to the processing described in FIG. 24, the management apparatus 2 can change the information associated with the task that belongs to the business process for the transfer destination. As a result, the administrator and the executor can update the information in accordance with actual operations.

Further, only when the information associated with the task that belongs to the business process for the transfer destination is changed, the management apparatus 2 stores the content of change. For example, there is a case where the executor erroneously selects the task that has already been transferred, from the task list, and the manipulation of change is carried out for the name of the executor of this task. Even in this case, the content of the task of the business process for the transfer source is not changed, so that the content of the task prior to the change can be maintained. As a result, the administrator and the executor can recognize how the information associated with the task to be the target of transfer is changed, by comparing the information on the task of the business process for the transfer source and the information on the task of the business process for the transfer destination.

(Display of Task History)

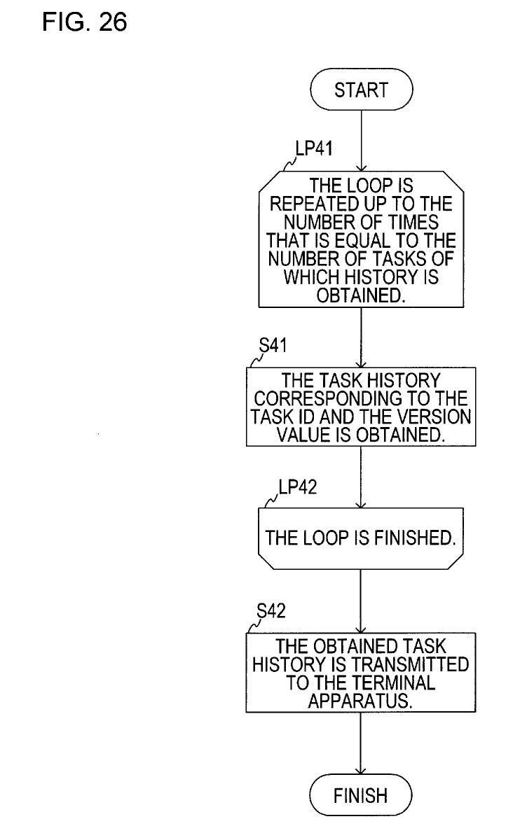

The processing of task history display described in FIG. 14 will be described referring to FIGS. 14, 20, and 21, based on FIG. 26.

FIG. 26 is a flowchart illustrating one example of the flow of the processing of the task history display. It is assumed that the following processing is carried out before the execution of the processing in FIG. 26. That is, the administrator selects the task whose history needs to be displayed, from the task list on the business process display screen U10 in FIG. 14. Then, the input/output control unit 151 of the first terminal apparatus 1_1 displays the drop-down list U101. As is described in FIG. 11, the administrator selects “initial research report” from the business process list.

The administrator selects “history” from the drop-down list U101. The input/output control unit 151 of the first terminal apparatus 1_1 transmits the control command corresponding to the select manipulation to the overall management unit 221 of the management apparatus 2.

The control command is one example of a history display instruction command that includes the task ID of the task whose history is to be displayed (whose history to be a target of a display) and the business process ID of the business process to which the task, whose history is to be displayed, belongs. The task whose history is to be displayed is the selected task. The business process to which the task, whose history is to be displayed, belongs is the selected business process. In the example described above, the business process ID is “11”, and the task ID is “15”.

When the overall management unit 221 receives the control command, the overall management unit 221 transmits the control command to the task control unit 223. When the task control unit 223 receives the control command, the task control unit 223 executes the processing in FIG. 26.

Step S41: The task control unit 223 obtains the history corresponding to the task ID and the version value.

Specifically, the task control unit 223 obtains the version value corresponding to the business process ID and the task ID contained in the control command from the correlation information table T31 in FIG. 21. In the example described above, the version value corresponding to the business process ID “11” and the task ID “15” is “1.0”. Then, the task control unit 223 obtains the history corresponding to the task ID contained in the control command and the obtained version value from the task history information table T41 in FIG. 22. In the example described above, the task control unit 223 obtains “yyyy2/mm2/dd2 hh2:mm2:ss2 start” and “yyyy4/mm4/dd4 hh4:mm4:ss4 completion” corresponding to the task ID “15” and the version value “1.0” from the task history information table T41 in FIG. 22.

In FIG. 14, M sets of tasks (M is an integer) are simultaneously selected, the input/output control unit 151 of the first terminal apparatus 1_1 transmits the control commands including M sets of task IDs. In this case, the task control unit 223 repeats the processing of the step S41 M times, in other words, up to the number of times that is equal to the number of tasks whose history is to be obtained (see Loop LP41 to Loop LP42).

Step S42: The task control unit 223 transmits the obtained history to the first terminal apparatus 1_1.

Specifically, the business process control unit 222 transmits the obtained history to the overall management unit 221. The overall management unit 221 generates the screen data for history display based on the history and transmits the screen data to the first terminal apparatus 1_1.

When the input/output control unit 151 of the first terminal apparatus 1_1 receives the screen data, the input/output control unit 151 displays the history display screen based on the screen data. In the example described above, the input/output control unit 151 displays the history display screen U102 in FIG. 14.

According to the processing described in FIG. 26, the management apparatus 2 can display the history of the task on the first terminal apparatus 1_1. As a result, the administrator and the executor can recognize the history of the task and the progress status of the business process in detail.

According to one aspect of the present invention, when a task is transferred in a plurality of business processes, the management apparatus manages a task to be the target of transfer and the business process for a transfer source, both of which are correlated, and further manages the task to be the target of transfer and the business process for a transfer destination, both of which are correlated. As a result, information associated with the task to be the target of transfer can be transferred to the business process for the transfer destination while the information associated with the task to be the target of transfer remains in the business process for the transfer source.

According to the management apparatus of the first embodiment of the present invention, even when the task is transferred between the business processes, the information associated with the task to be the target of transfer can be taken over to the business process for the transfer destination. Accordingly, the administrator only have to select the task to be the target of transfer and carry out the manipulation of transfer instruction, so that there is no need that the administrator himself inputs the information associated with the task to be the target of transfer in the management apparatus. As a result, the work load of the administrator in the input operation can be alleviated. In particular, in the cases where there is a number of tasks to be transferred or the types of information associated with the task to be the target of transfer are plentiful, or the amount of the information is great, the effect of alleviating the work load in the input operation is remarkable.

In the management apparatus, the task ID is not changed before or after the transfer of the task, the processing of task management is not complicated.

Further, when the task is transferred, the information associated with the task is managed in the business process for the transfer source. Accordingly, the administrator and the executor can recognize the information associated with the task, along with the execution history of the business process for the transfer source. As a result, the administrator and the executor can recognize the progress status of the business process for the transfer source. In particular, when a review meeting is held later in terms of the progress status and the business content of the business process for the transfer source, the participants of the review meeting can obtain the information associated with the task to be the target of transfer in the business process for the transfer source, thereby providing more review materials, which is desirable for the participants of the review meeting.

### Second Embodiment

In the first embodiment, the corresponding information includes the version value. In the second embodiment, the example in which the corresponding information includes flags will be described.

The difference between the first embodiment and the second embodiment is the content of the tables. In accordance with the difference, the content of the processing with regards to the overall management unit 221, the business process control unit 222, the task control unit 223, and the task transfer control unit 224 in FIG. 2 is different from that of the first embodiment. For example, the task control unit 223 generates the corresponding information including a flag indicating the presence or absence of the transfer of the task.

(Table)

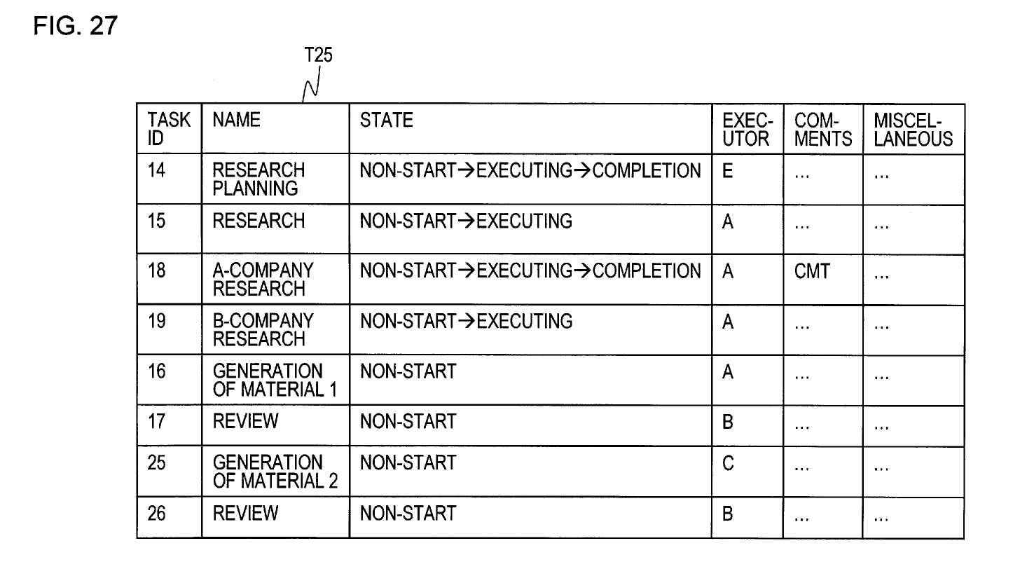

FIG. 27 is a diagram illustrating another example of the task information table T2 in FIG. 16 described in the first embodiment. A task information table T25 in FIG. 27 is different from the task information table T2 and does not include the version value. Except for the version value, the task information table T25 has the same configuration as that of the task information table T2.

In the second embodiment, the task information table T25 is one example of a first table for storing the task association information and the task ID which are correlated.

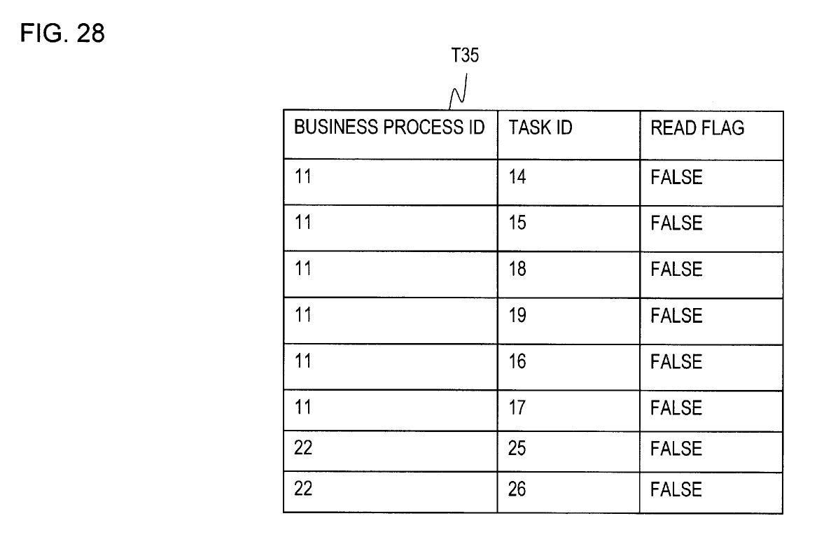

FIG. 28 is a diagram illustrating another example of the correlation information table T3 in FIG. 17 described in the first embodiment. In the second embodiment, a correlation information table T35 in FIG. 28 is one example of a second table for storing the business process ID, the task ID and the flag which are correlated. The correlation information table T35 in FIG. 28 is different from the correlation information table T3 and includes a read flag column in place of the version value column. Except for the read flag column, the correlation information table T35 has the same configuration as that of the correlation information table T3.

The read flag column stores the flag to determine whether the task identified by the task ID column is the task that has transferred between the business processes. When the task identified by the task ID column is the task that has transferred between the business processes, the read flag column stores “true”. In contrast, when the task identified by the task ID column is not the task that has transferred between the business processes, the read flag column stores “false”.

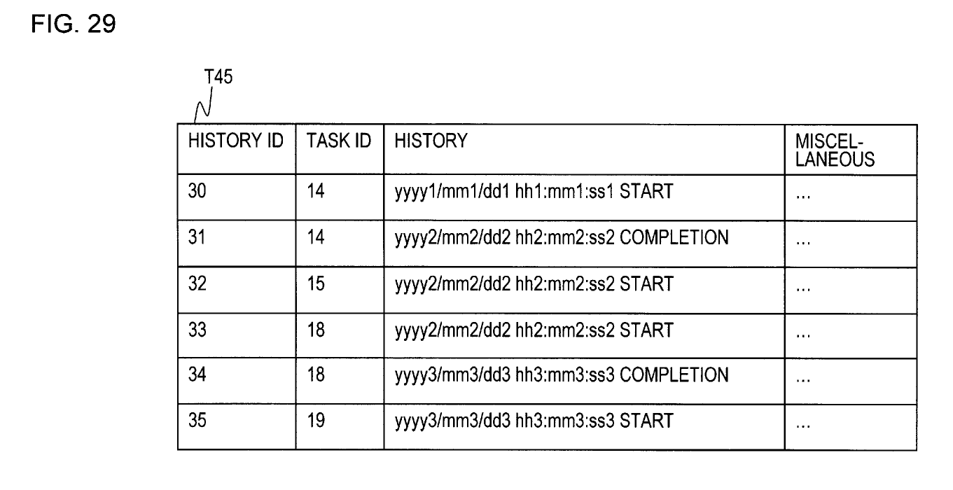

FIG. 29 is a diagram illustrating another example of the task history information table T4 in FIG. 18 described in the first embodiment. In the second embodiment, a task history information table T45 in FIG. 29 is one example of a fourth table for storing the task ID and the history of the task. The task history information table T45 is different from the task history information table T4 and does not include the version value column. Except for the version value, the task history information table T45 has the same configuration as that of the task history information table T4.

It is noted that the business process information table has the same configuration as that of the process information table T1 in FIG. 15 described in the first embodiment.

(Generation of Table)

Next, the processing of generating the task information table T25 in FIG. 27, the correlation information table T35 in FIG. 28, and the task history information table T45 in FIG. 29 will be described.

As is described in FIG. 16 in the first embodiment, the business process control unit 222 in FIG. 2 stores the task ID, the task name, the state, the executor, and the comments, respectively in the task ID column, in the name column, in the state column, in the executor column, and in the comment column in the task information table T25 in FIG. 27.

As is described in FIG. 17 in the first embodiment, the task control unit 223 in FIG. 2 stores the task ID and business process ID, respectively in the task ID column and business process ID column in the correlation information table T35 in FIG. 28. In this case, the task control unit 223 stores “false” in the read flag column corresponding to the task ID stored in the task ID column.

As is described in FIG. 18 in the first embodiment, the task control unit 223 in FIG. 2 stores the history ID, the task ID, and the history, respectively in the history ID column, the task ID column, and the history column in the task history information table T45 in FIG. 29.

(Task Transfer Processing)

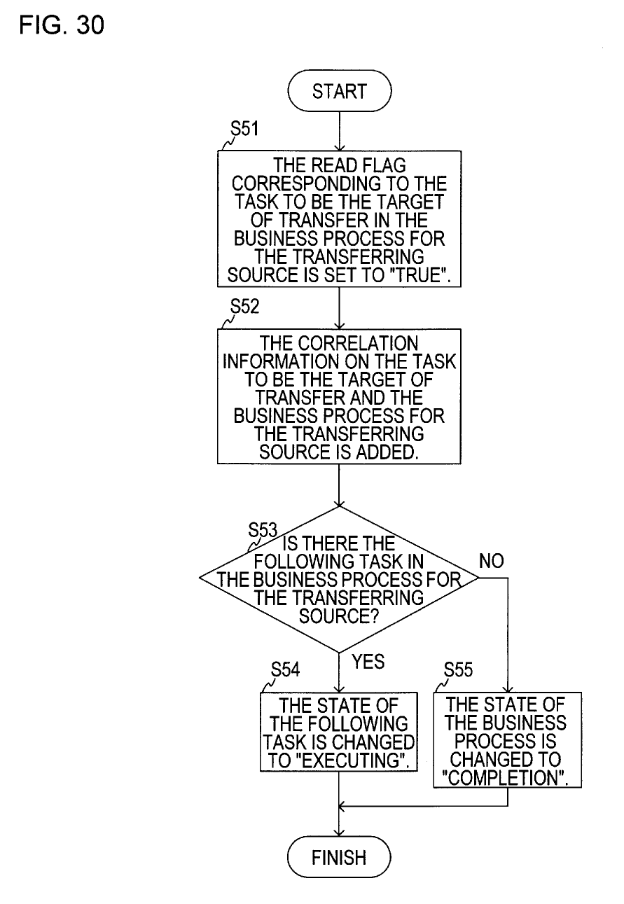

The flow of task transfer processing executed by the management apparatus 2 will be described referring to FIGS. 11, 28, and 29, based on FIGS. 30 to 33.

FIG. 30 is a flowchart illustrating another example of the flow of task transfer processing executed by the management apparatus 2.

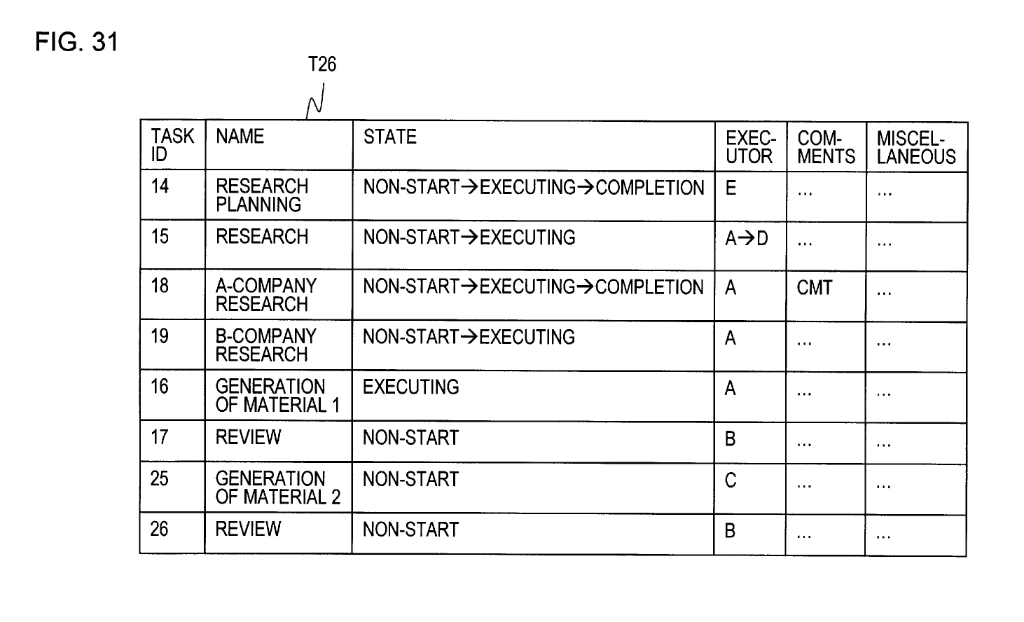

FIG. 31 is a diagram illustrating one example of a state where the task information table T25 in FIG. 27 is updated.

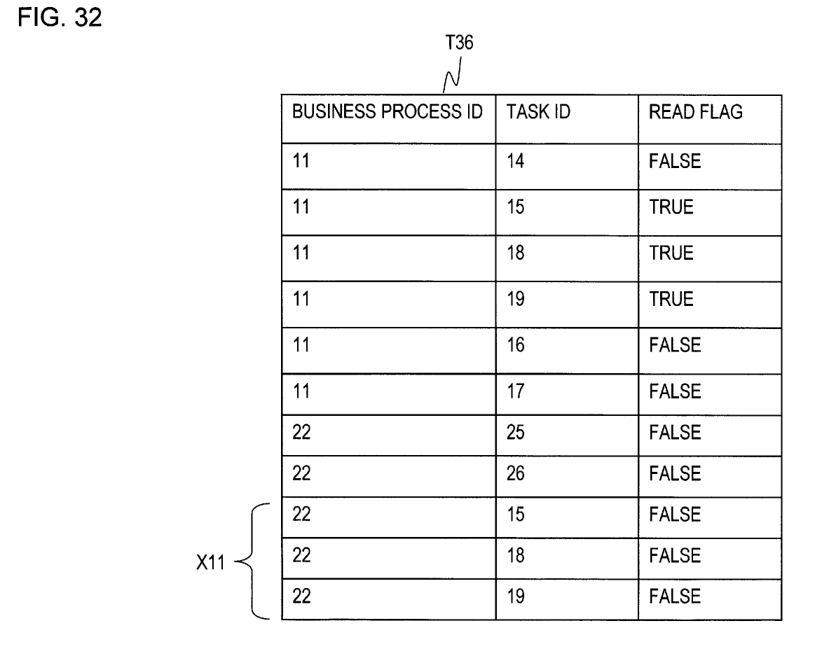

FIG. 32 is a diagram illustrating one example of a state where the correlation information table T35 in FIG. 28 is updated.

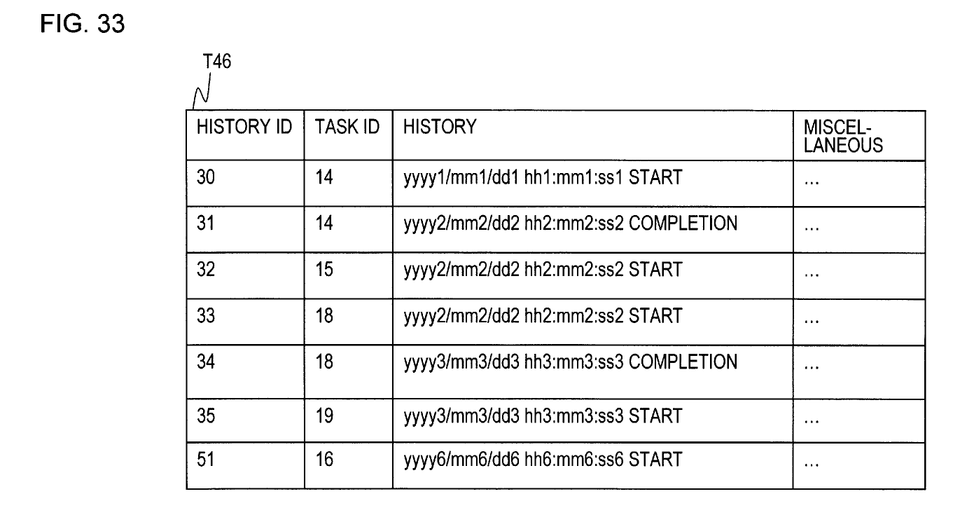

FIG. 33 is a diagram illustrating one example of a state where the task history information table T45 in FIG. 29 is updated.

It is assumed that the following processing is carried out before the execution of the processing in FIG. 30. That is, as is described in FIG. 11, the administrator selects the task to be the target of transfer from the task list, selects “transfer” from the drop-down list U71 displayed by carrying out the manipulation of drop-down list display instruction, and further downwardly pushes “transfer” button on the retrieval result screen U73 displayed by the select manipulation. The input/output control unit 151 of the first terminal apparatus 1_1 transmits the control command corresponding to the downwardly-pushing manipulation to the overall management unit 221 of the management apparatus 2.

The control command includes the ID of the task to be the target of transfer, the ID of the business process for the transfer source for the task, and the ID of the business process for the transfer destination for the task. In the example of FIG. 11, the control command includes the task ID “15” of the task to be the target of transfer, the business process ID “11” of the business process for the transfer source, and the business process ID “22” of the business process for the transfer destination for the task.

When the overall management unit 221 of the management apparatus 2 receives the control command, the overall management unit 221 transmits the control command to the task transfer control unit 224. When the task transfer control unit 224 receives the control command, the task transfer control unit 224 sets the flag of the task to be the target of transfer in the business process for the transfer destination to the first value and changes the flag of the task to be the target of transfer in the business process for the transfer source to the second value, in response to the task transfer instruction. The first value, for example, is “false”, and the second value, for example, is “true”. Hereinafter, the specific processing will be described referring to FIG. 30.

Step S51: The task transfer control unit 224 sets the read flag, corresponding to the task to be the target of transfer in the business process for the transfer source, to “true”. Specifically, in a correlation information table T36 in FIG. 32, the task transfer control unit 224 sets the flag, corresponding to the task ID and business process ID of the business process for the transfer source in the control command, to “true”. As is described in FIG. 19, when the task identified by the task ID is the main task, the subtasks of the main task are also the task to be the target of transfer.

In the example described above, the task to be the target of transfer is the main task, and the subtasks are “A-company research” and “B-company research”, and the IDs of the subtasks are “18” and “19”. Accordingly, the task transfer control unit 224 stores “true” in the read flag column corresponding to business process ID “11” and the task IDs “15” “18” and “19” in the correlation information table T36 in FIG. 32.

Step S52: The task transfer control unit 224 adds the information corresponding to the task to be the target of transfer and the business process for the transfer destination. Specifically, the task transfer control unit 224 adds the ID of the task to be the target of transfer in the task ID column in the correlation information table T35 in FIG. 28 and stores the ID of business process for the transfer destination in the business process ID column corresponding to the task ID to be added. The task transfer control unit 224 stores “false” in the read flag column corresponding to the task ID to be added in the correlation information table T35.

In the example described above, the task transfer control unit 224 stores the IDs “15” “18”, and “19” of the tasks to be transferred in the task ID columns, as is illustrated in the correlation information table T36 in FIG. 32. The task transfer control unit 224 stores the ID “22” of “second research report”, which is the business process for the transfer destination, in the business process ID column corresponding to the task IDs “15” “18”, and “19” and stores “false” in the read flag column corresponding to the task IDs “15” “18”, and “19” (see a reference number X11).

In other words, the task transfer control unit 224 stores and correlates the task ID of the task to be the target of transfer, the business process ID of business process for the transfer destination, and the flag including the first value (“false”).

Step S53: The task transfer control unit 224 determines whether there is a task to be executed subsequent to the task to be the target of transfer in the business process for the transfer source. The processing of the step S53 is similar to that of the step S7 in FIG. 19, and the detailed description is omitted. When there is the following task (step S53/YES), the process goes to the step S54. When there is no following task (step S53/N0), the process goes to the step S55.

Step S54: The task transfer control unit 224 changes the state of the following task to “executing” in the task information table T25 in FIG. 27. The task transfer control unit 224 newly generates a history ID corresponding to the following task in the task history information table T45 in FIG. 29, stores the history ID in the history ID column in the task history information table T45 in FIG. 29, and stores the ID of the following task in the task ID column. For example, the task transfer control unit 224 stores the character string “start” in the history column corresponding to the history ID, along with the date and time when the history ID is generated.

In the example described above, the task transfer control unit 224 changes the state of the following task having the task ID “16” to “executing” in a task information table T26 in FIG. 31. As is illustrated in a task history information table T46 in FIG. 33, the task transfer control unit 224 stores the history ID “51” corresponding to the task ID “16” of the following task (generation of material 1) in the history ID column, stores the task ID “16” in the task ID column, and stores “yyyy6/mm6/dd6 hh6:mm6:ss6 start” in the history column.

Step S55: The task transfer control unit 224 changes the state of the business process for the transfer source to “completion”. The processing of the step S55 is similar to that of the step S9 in FIG. 19, and the detailed description is omitted.

According to the processing in FIG. 30, as is described in the step S52, the management apparatus 2 can manage the task to be the target of transfer that is correlated with the business process for the transfer source and the business process for the transfer destination, based on the correlation information table T36 in FIG. 32. As a result, even when the task is transferred between the business processes, the management apparatus 2 can execute the control in such a manner that the business process for the transfer destination automatically takes over the task in the business process for the transfer source and information associated with the task.

(Display of Business Process List and Task List)

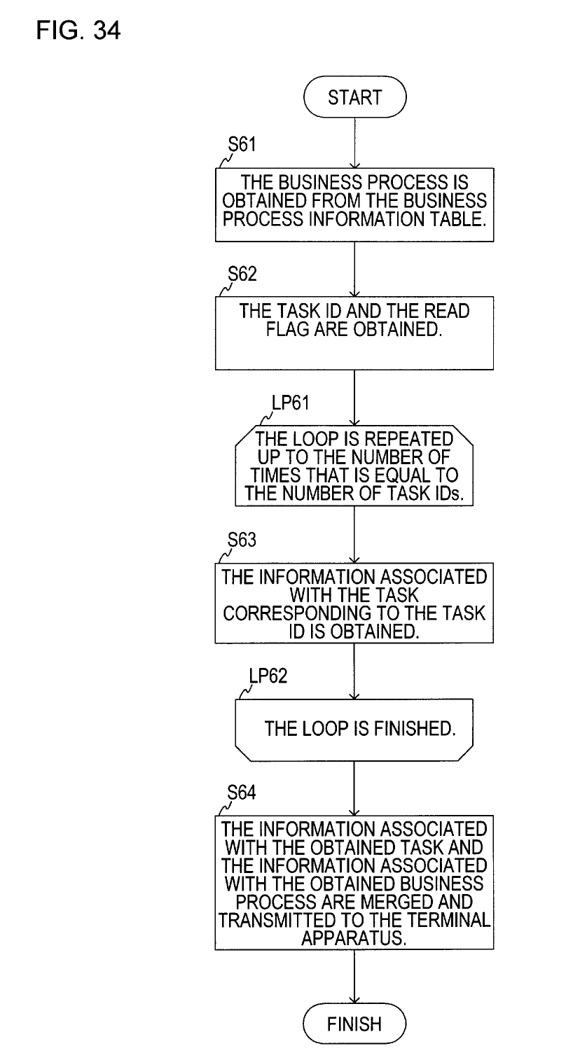

As is described in FIGS. 11 and 12, the processing of displaying the business process list in the business process list display column R1 and the task list in task list display column R4 on the business process display screen will be described referring to FIGS. 11, 12, 15, 31 and 32, based on FIG. 34.

FIG. 34 is a flowchart illustrating another example of the flow of the processing of displaying the business process list and the task list. It is assumed that the management apparatus 2 executes the task transfer processing described in the flowchart in FIG. 30 before the execution of the processing in FIG. 34 and stores the task information table T26 in FIG. 31 and the correlation information table T36 in FIG. 32 in the storing device 14. Further, as is described in FIG. 11, it is assumed that the administrator selects “second research report”, which is the business process for the transfer destination, from the business process list on the business process display screen U7.

As a result, the input/output control unit 151 of the first terminal apparatus 1_1 transmits the control command corresponding to the select manipulation to the overall management unit 221 of the management apparatus 2. The control command includes the ID of the selected business process (also referred to as the business process to be displayed) and the information indicating the task list display. In the case of FIG. 11, the control command includes the business process ID “22”.

When the overall management unit 221 of the management apparatus 2 receives the control command, the overall management unit 221 transmits the control command to the task transfer control unit 224. When the task transfer control unit 224 receives the control command, the task transfer control unit 224 executes the processing in FIG. 34.

Step S61: The business process control unit 222 obtains the information associated with the selected business process from the process information table T1 in FIG. 15. Specifically, the business process control unit 222 obtains the business process name, state, and process initiator corresponding to the business process ID contained in the control command from the process information table T1 in FIG. 15. In the example described above, the business process control unit 222 obtains “second research report” as the business process name, “executing” as the state, and “BBB” as the process initiator, corresponding to the business process ID “22”.

Step S62: The business process control unit 222 obtains the task ID of the task in the selected business process and the read flag of the task from the correlation information table T36 in FIG. 32. In the example described above, the business process control unit 222 obtains the IDs “15” “18” “19” “25”, and “26” of the tasks that belong to “second research report”, which is the business process specified by the business process ID “22” and obtains the read flag “false”.

Step S63: The business process control unit 222 obtains the information associated with the task corresponding to each task ID to be obtained from the task information table T26 in FIG. 31. The business process control unit 222 repeats the acquisition processing up to the number of times that is equal to the number of task IDs to be obtained (see Loop LP61 to Loop LP62). In the example described above, regarding the tasks to be obtained, the task IDs are “15” “18” “19” “25”, and “26′, and the read flag to be obtained is “false”. Accordingly, the business process control unit 222 obtains the task names “research”, “A-company research”, “B-company research”, “generation of material 2”, and “review”, as the information associated with the task, and respectively “executing”, “completion”, “executing”, “non-start”, and “non-start”, as the states, from the task information table T26 in FIG. 31. The business process control unit 222 obtains the process initiator “A” “A” “A” “C”, and “B” from the task information table T21 and the comments “CMT” as the “A-company research” task, from the task information table T21.

Step S64: The business process control unit 222 merges the obtained task IDs and the obtained information associated with the task and the obtained information associated with the business process and transmits the merged information to the first terminal apparatus 1_1.

The processing of the step S64 has been described in the step S24 in FIG. 23 in detail, and the description regarding the step S64 is omitted.

According to the processing described in in FIG. 34, the management apparatus can provide the information on the business process and the information on the task in the business process for the administrator and the executor.

(Change of Task Association Information)

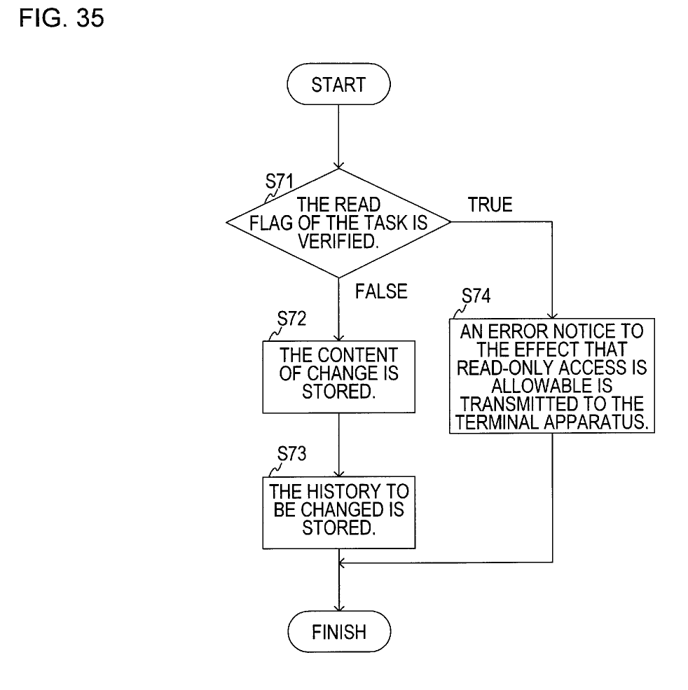

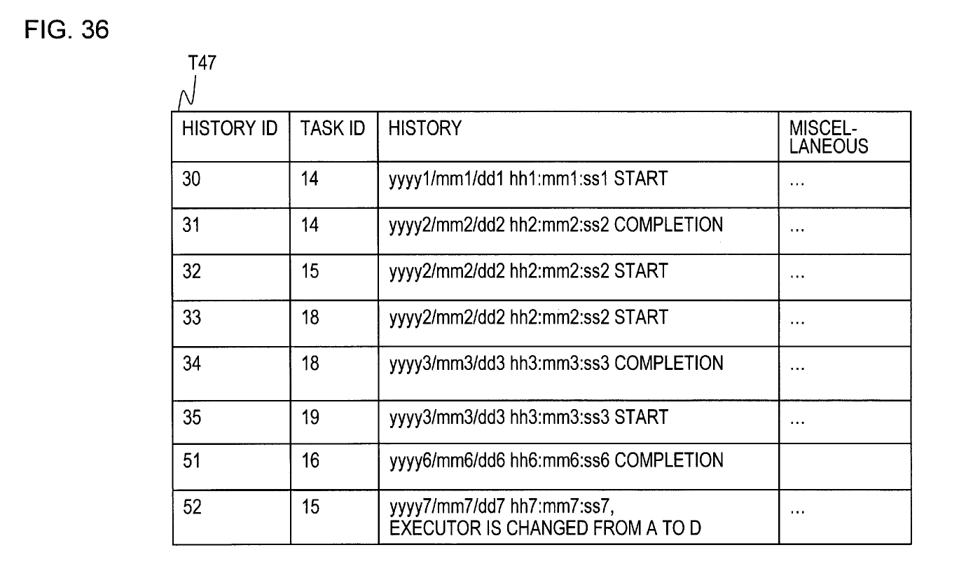

As is described in FIG. 13, the processing of changing the executors of the task or the comments of the task will be described referring to FIGS. 13, 31 and 32, based on FIGS. 35 and 36. Hereinafter, as a specific example, the change of the executors of the task is exemplified, but the change of comments of the task is also applied.

FIG. 35 is a flowchart illustrating another example of the flow of the processing of changing the task association information.

FIG. 36 is a diagram illustrating one example of a state where the task history information table T46 in FIG. 33 is updated.

It is assumed that the following processing is carried out before the execution of the processing in FIG. 35. That is, as is described in FIG. 13, the administrator selects the task which is a target of change of executors, from the task list on the business process display screen U9 in FIG. 13 and selects “change of executor” from the drop-down list U91. As is described in FIG. 12, the administrator selects “second research report” from the business process list.

When the executor name “D” is inputted in the text box in the executor change column on the executor change screen U93, and the save button is downwardly pushed, the input/output control unit 151 of the first terminal apparatus 1_1 transmits the control commands corresponding to the input manipulation and the downwardly-pushing manipulation to the overall management unit 221 of the management apparatus 2. The control commands include the ID of the selected task, the ID of the business process to which the task belongs (the ID of the business process to be selected), and the content of change. In the example described above, the business process ID is “22”, and the task ID is “15”, and the content of change is the name of the executor to be inputted.

When the overall management unit 221 receives the control command, the overall management unit 221 transmits the control command to the task control unit 223. When the task control unit 223 receives the control command, the task control unit 223 executes the processing in FIG. 35.

Step S71: The task control unit 223 verifies whether the read flag of the selected task is “false” or “true”. When the read flag of the selected task is “false”, the process goes to a step S72. When the read flag of the selected task is “true”, the process goes to a step S74.

Specifically, the task control unit 223 obtains the read flag corresponding to the business process ID and the task ID contained in the control command from the correlation information table T36 in FIG. 32. Then, the task control unit 223 determines whether the read flag to be obtained is “false”.

In the example described above, the read flag corresponding to the business process ID “22” and the task ID “15” is “false”. Accordingly, the process goes to the step S72.

Step S72: The task control unit 223 stores the content of change. Specifically, the task control unit 223 changes the associated information corresponding to the task ID contained in the control command to the content of change, which is the associated information after the change, in the task information table T26 in FIG. 31. In the example described above, the task control unit 223 changes the executor, in the executor column corresponding to the task ID “15”, to “D” (“A” “D”).

Step S73: The task control unit 223 stores the history to be changed. Specifically, the task control unit 223 newly generates a history ID, stores the history ID in the history ID column in a history information table T47 in FIG. 36, and stores the task ID contained in the control command, in the task ID column corresponding to the history ID column. Then, for example, the task control unit 223 stores the date and time when the history ID is generated, in the history column, and further stores the content of change, contained in the control command. In the example described above, as is described in FIG. 36, the history ID “52” to be generated is stored in the history ID column, and the task ID “15” is stored in the task ID column, and “yyyy7/mm7/dd7 hh7:mm7:ss7, Executor Change A D” is stored in the history column.

Step S74: The task control unit 223 transmits the error notice to the effect that read-only access is allowable, to the input/output control unit 151 of the first terminal apparatus 1_1. When the input/output control unit 151 receives the error notice, the input/output control unit 151 displays that read-only access is allowable, on the display device 121.

According to the processing described in FIG. 24, the management apparatus 2 can change the information associated with the task that belongs to the business process for the transfer destination. As a result, the administrator and the executor can update the information in accordance with actual operations. Further, the updated content of the task can be read from the transfer source while maintaining the task history before transfer.

(Display of Task History)

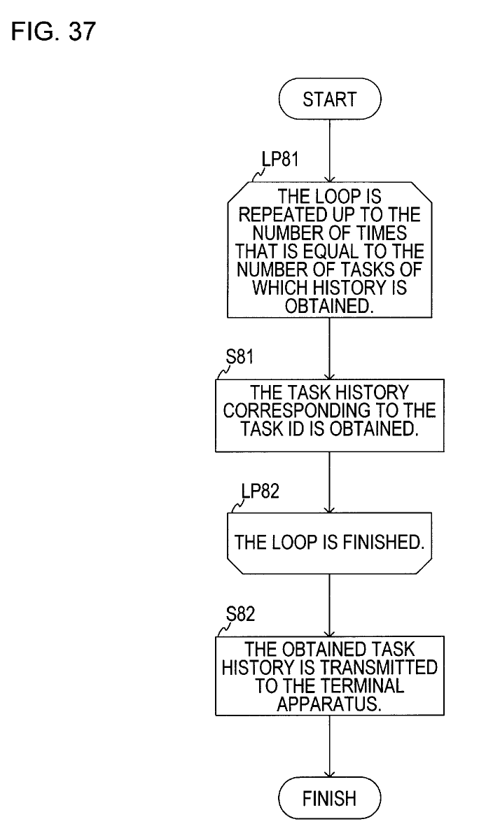

The processing of the task history display described in FIG. 14 will be described referring to FIGS. 14 and 33, based on FIG. 37.

FIG. 37 is a flowchart illustrating another example of the flow of the processing of the task history display. It is assumed that the following processing is carried out before the execution of the processing in FIG. 37. That is, the administrator selects the task whose history needs to be displayed from the task list on the business process display screen U10 in FIG. 14. Then, the input/output control unit 151 of the first terminal apparatus 1_1 displays the drop-down list U101. As is described in FIG. 11, the administrator selects “initial research report” from the business process list.

The administrator selects “history” from the drop-down list U101. The input/output control unit 151 of the first terminal apparatus 1_1 transmits the control command corresponding to the select manipulation to the overall management unit 221 of the management apparatus 2. The control command includes the ID of the selected task and the ID of the selected business process. In the example described above, the business process ID is “11”, and the task ID is “15”.

When the overall management unit 221 receives the control command, the overall management unit 221 transmits the control command to the task control unit 223. When the task control unit 223 receives the control command, the task control unit 223 executes the processing in FIG. 37.

Step S81: The task control unit 223 obtains the history based on the task ID.

Specifically, the task control unit 223 obtains the history corresponding to the task ID contained in the control command from the task history information table T46 in FIG. 33. In the example described above, the task control unit 223 obtains “yyyy2/mm2/dd2 hh2:mm2:ss2 start” corresponding to the task ID “15” from the task history information table T46 in FIG. 33.

In FIG. 14, when M sets of tasks (M is an integer) are simultaneously selected, the input/output control unit 151 of the first terminal apparatus 1_1 transmits the control commands including M sets of task IDs. In this case, the task control unit 223 repeats the processing of the step S81 M times, in other words, up to the number of times that is equal to the number of tasks whose history is to be obtained (see Loop LP81 to Loop LP82).

Step S82: The task control unit 223 transmits the obtained history to the first terminal apparatus 1_1. The processing of the step S82 is similar to that of the step S42 in FIG. 26, and the detailed description is omitted.

According to the processing described in FIG. 37, the management apparatus 2 can display the history of the task on the first terminal apparatus 1_1. As a result, the administrator and the executor can recognize the history of the task and the progress status of the business process in detail.

According to the management apparatus 2 according to the embodiment of the present invention, even when the task is transferred between the business processes, the information associated with the task to be the target of transfer can be taken over to the business process for the transfer destination.

In the management apparatus, the task ID is not changed before or after the transfer of the task, the processing of task management is not complicated.

Even when the task is transferred, the information associated with the task is managed in the business process for the transfer source. Accordingly, the administrator and the executor can recognize the information associated with the task. Further, the correlation tables only store the flag to identify the task to be the target of transfer. Consequently, the configuration of the tables does not lead to complication, which reduces loads in the course of processing of generating the tables and loads in the course of the processing of management. Further, the memory capacity of the tables can be reduced, and the memory capacity of the storage devices can be saved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management apparatus configured to manage progress of a plurality of tasks in a business process which is represented a flow of the tasks, the management apparatus comprising:
a storing unit configured to store business process association information associated with the business process and task association information associated with the task in the business process; and
a control unit configured to generate correlation information in which the business process association information and the task association information are correlated, and configured to store the correlation information in the storing unit,
wherein, the control unit, in response to a transfer instruction that transfers the task to be a target of transfer in a first business process to a second business process, generates the correlation information in which the business process association information on the second business process and the task association information on the task to be a target of transfer are correlated, and based on the correlation information, obtains the task association information on the task in the first business process and the task association information on the task in the second business process for use of management of the business process.

2. The management apparatus, according to claim 1,
wherein the control unit generates the correlation information including a version numerical value indicating the number of times regarding transfer of the task, and
wherein, in response to the transfer instruction, the control unit sets a version numerical value of the task to be the target of transfer in the second business process to a first value and changes a version numerical of the task to be the target of transfer in the first business process to a second value corresponding to the number of times regarding the transfer.

3. The management apparatus, according to claim 2,
wherein the control unit generates the correlation information including a business process identifier that identifies the business process and a task identifier that identifies the task in the business process, and
wherein the storing unit stores a first table that stores and correlates the task association information, the task identifier, and the version numerical value, and a second table that stores and correlates the business process identifier, the task identifier, and the version numerical value, and
wherein, in response to a task transfer instruction command that includes a business process identifier of the first business process, the task identifier of the task to be the target of transfer, and a business process identifier of the second business process, and that is inputted as the transfer instruction,
with respect to the first table, the control unit stores reproductions of the task identifier of the task to be the target of transfer and the task association information, stores a version numerical value of the first value corresponding to the task association information to be reproduced, and changes a version numerical value of the task to be the target of transfer to the second value,
with respect to the second table, the control unit changes a version numerical value, corresponding to the business process identifier of the first business process and the task identifier of the task to be the target of transfer, to the second value, further stores and correlates the task identifier of the task to be the target of transfer, the business process identifier of the second business process, and the version numerical value including the first value.

4. The management apparatus, according to claim 3,
wherein the storing unit stores a third table that stores and correlates the business process association information and the business process identifier of the business process, and
wherein, in response to a display instruction command of a business process to be displayed that includes the business process identifier of the business process to be displayed, the control unit obtains the business process association information of the business process to be displayed, from the third table, and
wherein the control unit obtains the task identifier and the version numerical value of the task in the business process to be displayed, from the second table, and
wherein the control unit obtains the task association information on the task in the business process to be displayed, corresponding to the task identifier and the version numerical value to be obtained, from the first table, and generates display data with respect to the business process association information and the task association information to be obtained.

5. The management apparatus, according to claim 4,
wherein, in response to a task change instruction command that includes the task identifier of a task to be changed, the business process identifier of the business process to which the task to be changed belongs, and the task association information after change regarding the task to be changed, the control unit obtains a version numerical value corresponding to the business process identifier of the business process to which the task to be changed belongs and the task identifier of the task to be changed, from the second table, and determines whether the version numerical value to be obtained is the first value, and
wherein, when the version numerical value to be obtained is the first value, the control unit changes the task association information, corresponding to the task identifier of the task to be changed and the version numerical value to be obtained, to the task association information after the change regarding the task to be changed, in the first table.

6. The management apparatus, according to claim 4,
wherein the storing unit stores a fourth table that stores the task identifier of the task, the version numerical value of the task, and history of the task, and
wherein, in response to the task transfer instruction command, in the fourth table, the control unit stores reproductions of the task identifier and the history of the task to be the target of transfer, stores the version numerical value of the first value corresponding to the reproduction of the history, and changes the version numerical value of the task to be the target of transfer to the second value, and
wherein, in response to a history display instruction command that includes a task identifier of a task whose history is to be displayed and the business process identifier of the business process to which the task, whose history is to be displayed, belongs, the control unit obtains a version numerical value corresponding to the business process identifier of the business process to which the task, whose history is to be displayed, belongs, and corresponding to the task identifier of the task whose history is to be displayed, from the second table, and
wherein the control unit obtains history corresponding to the task identifier of the task whose history is to be displayed and the version numerical value to be obtained, from the fourth table, and generates display data for the history.

7. The management apparatus, according to claim 1,
wherein the control unit generates the correlation information including a flag indicating presence or absence of the transfer of the task, and
wherein, in response to the transfer instruction, the control unit sets the flag of the task to be the target of transfer in the second business process to the first value and changes the flag of the task to be the target of transfer in the first business process to the second value.

8. The management apparatus, according to claim 7,
wherein the control unit generates the correlation information including the business process identifier that identifies the business process and the task identifier that identifies the task in the business process, and
wherein the storing unit stores the first table that stores and correlates the task association information and the task identifier, and the second table that stores and correlates the business process identifier, the task identifier, and the flag, and
wherein, in response to a task transfer instruction command that includes the business process identifier of the first business process, the task identifier of the task to be the target of transfer, and the business process identifier of the second business process and that is inputted as the transfer instruction, in the second table, the control unit changes the flag, corresponding to the business process identifier of the first business process and the task identifier of the task to be the target of transfer, to the second value, and the control unit stores and correlates the task identifier of the task to be the target of transfer, the business process identifier of the second business process, and the flag including the first value.

9. The management apparatus, according to claim 8,
wherein the storing unit stores the third table that stores and correlates the business process association information and the business process identifier of the business process, and
wherein, in response to the display instruction command of the business process to be displayed that includes the business process identifier of the business process to be displayed, the control unit obtains the business process association information of the business process to be displayed from the third table, and obtains the task association information on the task in the business process to be displayed, corresponding to the task identifier of the task in the business process to be displayed from the first table, and generates display data with respect to the business process association information and the task association information to be obtained.

10. The management apparatus, according to claim 9,
wherein, in response to the task change instruction command that includes the task identifier of the task to be changed, the business process identifier of the business process to which the task to be changed belongs, and the task association information after the change regarding the task to be changed, the control unit obtains the flag corresponding to the business process identifier of the business process to which the task to be changed belongs and the task identifier of the task to be changed, from the second table, and determines whether the flag to be obtained is the first value, and
wherein, when the flag to be obtained is the first value, the control unit changes the task association information, corresponding to the task identifier of the task to be changed, to the task association information after the change regarding the task to be changed, in the first table.

11. The management apparatus, according to claim 9,
wherein the storing unit stores the fourth table that stores the task identifier of the task and the history of the task, and
wherein, in response to the history display instruction command that includes the task identifier of the task whose history is to be displayed, the control unit obtains the history corresponding to the task identifier of the task whose history is to be displayed from the fourth table and generates display data for the history.

12. A computer-readable, non-transitory recoding medium having stored therein a program for causing a computer to execute a digital signature process comprising:
generating correlation information in which business process association information associated with business process which is represented a flow of a plurality of tasks and task association information associated with the task in the business process are correlated;
storing the correlation information in a storing unit;
generating the correlation information in which the business process association information on a second business process and the task association information on a task to be the target of transfer are correlated, in response to a transfer instruction that transfers the task to be a target of transfer in a first business process to the second business process; and based on the correlation information, obtaining the task association information on the task in the first business process and the task association information on the task in the second business process for use of management of the business process.

13. A management method executed in a management apparatus configured to manage progress of a plurality of tasks in a business process which is represented a flow of the tasks, the management method comprising:
generating correlation information in which business process association information associated with the business process and task association information associated with the task in the business process are correlated by a processor;
storing the correlation information in a storing unit, by the processor;
generating the correlation information in which business process association information on a second business process and task association information on a task to be a target of transfer are correlated, in response to transfer instruction that transfers the task to be the target of transfer in a first business process to the second business process by the processor; and
obtaining the task association information on the task in the first business process and the task association information on the task in the second business process, based on the correlation information, by the processor, for use of management of the business process.
